(19) United States
(12) Patent Application Publication
(10) Pub. No.: US 2005/0037272 A1
(43) Pub. Date: Feb. 17, 2005

(54) Method and apparatus for manufacturing semiconductor

(75) Inventor: Toshihiko Tanaka, Yokohama-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Olympus Corporation, Tokyo (JP)

(21) Appl. No.: 10/935,467

(22) Filed: Sep. 7, 2004

Related U.S. Application Data
(63) Continuation of application No. PCT/JP03/02939, filed on Mar. 12, 2003.

(30) Foreign Application Priority Data
Mar. 12, 2002 (JP) 2002-067374

(51) Int. Cl. G03C 5/00; G03B 27/32; G03B 27/52

(52) U.S. Cl. 430/30; 430/311; 355/27

(57) ABSTRACT

In a method of manufacturing a semiconductor, in which a semiconductor substrate is worked/treated in each manufacturing step of a semiconductor manufacturing line, image data is acquired before and after working/treating the semiconductor substrate transported into a manufacturing apparatus disposed in each manufacturing step, respectively, defects attributed to treatment conditions of the manufacturing apparatus are detected from the image data before the working/treating, or non-defective master image data, and the image data after the working/treating, and the treatment conditions of the manufacturing apparatus are changed/controlled based on the detection result to work/treat the semiconductor substrate.

### CROSS-REFERENCE TO RELATED APPLICATIONS

This is a Continuation Application of PCT Application No. PCT/JP03/02939, filed Mar. 12, 2003, which was published under PCT Article 21(2) in Japanese.

This application is based upon and claims the benefit of priority from prior Japanese Patent Application No. 2002-067374, filed Mar. 12, 2002, the entire contents of which are incorporated herein by reference.

### BACKGROUND OF THE INVENTION

1. Field of the Invention

The present invention relates to a method and apparatus for manufacturing semiconductors for flat panel displays such as liquid crystal and plasma displays, semiconductor wafers and the like.

2. Description of the Related Art

FIGS. 21A to 21G show a pre-process of manufacturing a semiconductor. An oxide film (SiO2) is formed on the surface of a semiconductor wafer 1, and a thin film 2 of silicon nitride is deposited on the oxide film.

Next, the process shifts to a photolithography step, and a thin film of photoresist (photosensitive resin) 3 is applied to the surface of the semiconductor wafer 1. To apply the photoresist 3, a solution of the photoresist 3 is dropped onto the surface of the semiconductor wafer 1 by a coater (applying unit), and the semiconductor wafer 1 is rotated at high speed to apply the thin film of the photoresist 3 to the surface of the semiconductor wafer 1.

Next, in an exposure unit such as a stepper, ultraviolet rays are applied to the photoresist 3 on the semiconductor wafer 1 through a photo mask substrate (hereinafter referred to as the mask) 4. Accordingly, a semiconductor pattern drawn on the mask 4 is transferred (exposed) to the photoresist 3.

Next, developing is performed, accordingly the photoresist 3 of an exposure portion is dissolved by a solvent, and a resist pattern 3a of a non-exposed portion is left (positive type). Conversely, the photoresist 3 of the exposed portion is left, and the resist pattern 3a of the non-exposed portion is dissolved in a negative type.

When the developing ends, an appearance inspection of the resist pattern 3a formed on the surface of the semiconductor wafer 1 is performed.

Next, the resist pattern 3a left on the surface of the semiconductor wafer 1 is used as a mask, and the oxide film and the silicon nitride film on the surface of the semiconductor wafer 1 are continuously selectively removed (etched).

Next, the resist pattern 3a on the surface of the semiconductor wafer 1 is removed by ashing (resist peeling). Next, the semiconductor wafer 1 is cleaned, and impurities are removed.

Thereafter, steps of the applying of the photoresist 3 to the cleaning of the semiconductor wafer 1 are repeated to form a plurality of layers of patterns on the surface of the semiconductor wafer 1.

The applying of the photoresist 3 to the developing is performed by a photolithography device in which a coater/developer and an exposure unit are integrally systemized.

However, in the coater in the photolithography device, non-uniformity is generated in forming the film of the photoresist 3 onto the surface of the semiconductor wafer 1 by attached foreign matters, photoresist viscosity, and rotation conditions.

In the exposure unit, defocus occurs, the mask is mistaken, and another circuit pattern is transferred. A masking blade is excessively large or small. The unit is influenced by a defect on the mask 4. The unit is influenced by the foreign matters attached to the mask 4. The semiconductor wafer 1 is double exposed, or remains unexposed.

In the developer, a developing defect occurs by a temperature of a developing solution or a developing time.

Additionally, to perform the appearance inspection of the semiconductor wafer 1, for checking the defects, the semiconductor wafer 1 is once taken out of the photolithography device, and brought into an appearance inspection device outside the photolithography device.

Therefore, it is difficult to immediately detect defects attributed to operation conditions of the coater, exposure unit, and developer. As a result, a large amount of defective articles are generated, and semiconductors cannot be stably manufactured.

Then, an object of the present invention is to provide a semiconductor manufacturing method and apparatus in which defects associated with operation conditions of manufacturing apparatuses arranged in semiconductor manufacturing steps are detected to variously set the operation conditions of the respective manufacturing apparatuses to stably manufacture semiconductors.

### BRIEF SUMMARY OF THE INVENTION

According to an aspect of the present invention, there is provided a method of manufacturing a semiconductor, in which a semiconductor substrate is worked/treated in manufacturing steps of a semiconductor manufacturing line, the method comprising: acquiring image data with respect to the semiconductor substrate transported into a manufacturing apparatus disposed in the manufacturing step before and after the working/treating; comparing the image data before the working/treating or master image data of the semiconductor substrate with the image data after the working/treating to detect a worked/treated state attributed to operation conditions of the manufacturing apparatus; and changing the operation conditions of the manufacturing apparatus based on the detection result to work/treat the semiconductor substrate.

### BRIEF DESCRIPTION OF THE SEVERAL VIEWS OF THE DRAWING

FIG. 1A is a constitution diagram showing a first embodiment of a semiconductor manufacturing apparatus according to the present invention;

FIG. 1B is a diagram showing an arrangement example of a cassette, a reworking device, and a shipping robot in the apparatus;

FIG. 2 is a constitution diagram of a coater in the apparatus;

FIG. 3 is a diagram showing a relation between a rotation number of the coater and a resist film thickness using viscosity of a resist as a parameter;

FIG. 4A is a constitution diagram of an edge rinsing/cutting unit;

FIG. 4B is a diagram showing an edge rinsed cut width;

FIG. 5 is a diagram showing a cut in a photoresist in an outer peripheral edge of a semiconductor wafer;

FIG. 6 is a constitution diagram of a developer in the first embodiment of a semiconductor manufacturing apparatus according to the present invention;

FIG. 7 is a constitution diagram of an exposure unit in the apparatus;

FIG. 8 is a constitution diagram of first to third inspection sections in the apparatus;

FIG. 9 is a constitution diagram of a surface defect inspection device in the apparatus;

FIG. 10 is a diagram showing a relation of a luminance value to a tilt angle of an illumination section in the apparatus;

FIG. 11 is a constitution diagram of an inspection process section in the apparatus;

FIG. 12 is a diagram showing detected places of the edge rinsed cut width in the apparatus;

FIG. 13 is a constitution diagram of a step control device in the apparatus;

FIG. 14 is a schematic diagram showing a defect of photoresist application in the apparatus;

FIG. 15 is a schematic diagram showing an exposed state at a time when the semiconductor wafer is tilted in the apparatus;

FIG. 16 is a schematic diagram showing a developing defect in the apparatus;

FIG. 17 is a constitution diagram showing a second embodiment of the semiconductor manufacturing apparatus according to the present invention;

FIG. 18 is a schematic diagram of a defect database in the apparatus;

FIG. 19 is a constitution diagram showing a third embodiment of the semiconductor manufacturing apparatus according to the present invention;

FIG. 20 is a constitution diagram showing an application example of the apparatus;

FIG. 21A is a diagram showing a photolithography step in a semiconductor manufacturing process;

FIG. 21B is a diagram showing the photolithography step in the semiconductor manufacturing process;

FIG. 21C is a diagram showing the photolithography step in the semiconductor manufacturing process;

FIG. 21D is a diagram showing the photolithography step in the semiconductor manufacturing process;

FIG. 21E is a diagram showing the photolithography step in the semiconductor manufacturing process;

FIG. 21F is a diagram showing the photolithography step in the semiconductor manufacturing process; and

FIG. 21G is a diagram showing the photolithography step in the semiconductor manufacturing process.

### DETAILED DESCRIPTION OF THE INVENTION

A first embodiment of the present invention will be described hereinafter with reference to the drawings.

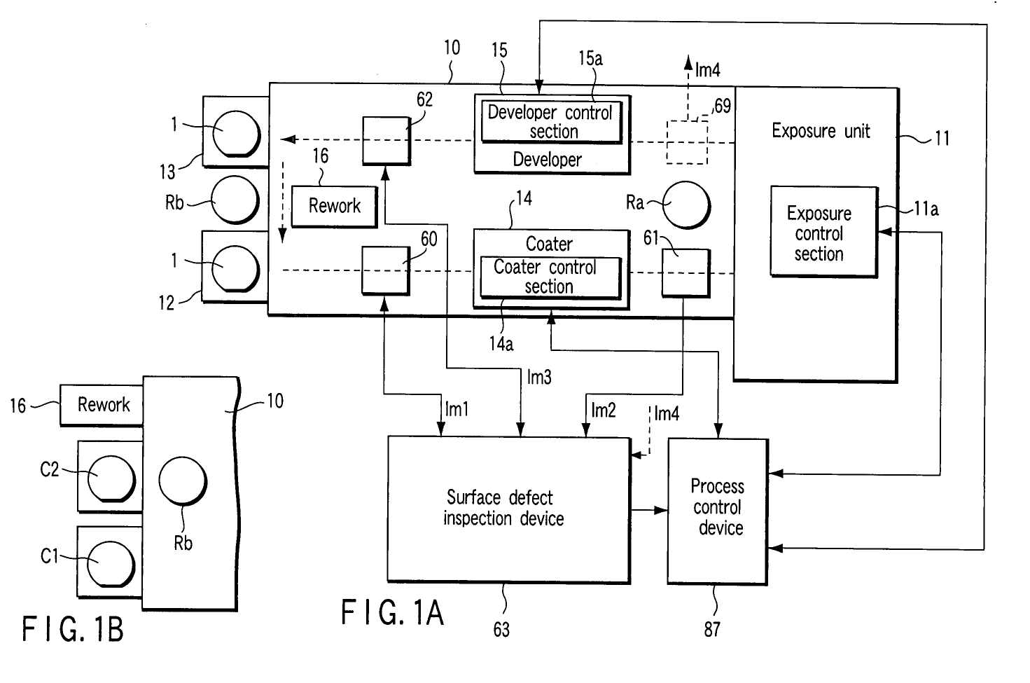

FIG. 1A is a constitution diagram of a semiconductor manufacturing apparatus disposed in a photolithography step. The semiconductor manufacturing apparatus includes a coater/developer 10 and an exposure unit 11. A cassette 12 is disposed in a throw-in port of the coater/developer 10. The cassette 12 stores a plurality of semiconductor wafers 1 before a photolithography process. A cassette 13 is disposed in a take-out port of the coater/developer 10. The cassette 13 stores the plurality of semiconductor wafers 1 subjected to the photolithography process.

In the coater/developer 10, a coater 14, a developer 15, a reworking device 16, and first to third inspection sections 60 to 62 are disposed.

It is to be noted that as shown in FIG. 1B, a cassette C1 storing a plurality of non-defective semiconductor wafers 1, a cassette C2 storing NG semiconductor wafers 1 which cannot be reworked, and a reworking device 16 are disposed outside the semiconductor manufacturing apparatus, and a shipping robot Rb may be disposed in the coater/developer 10. In the cassette C1, a plurality of semiconductor wafers 1 before the photolithography process, and a plurality of non-defective semiconductor wafers 1 subjected to the photolithography process are stored. The shipping robot Rb is movable between the respective cassettes C1, C2 and the reworking device 16. When the semiconductor wafer 1 subjected to the developing by the developer 15 is non-defective, the semiconductor wafer 1 is stored in the cassette C1. The reworkable semiconductor wafer 1 is fed into the reworking device 16, and the NG semiconductor wafer 1 that cannot be reworked is stored in the cassette C2.

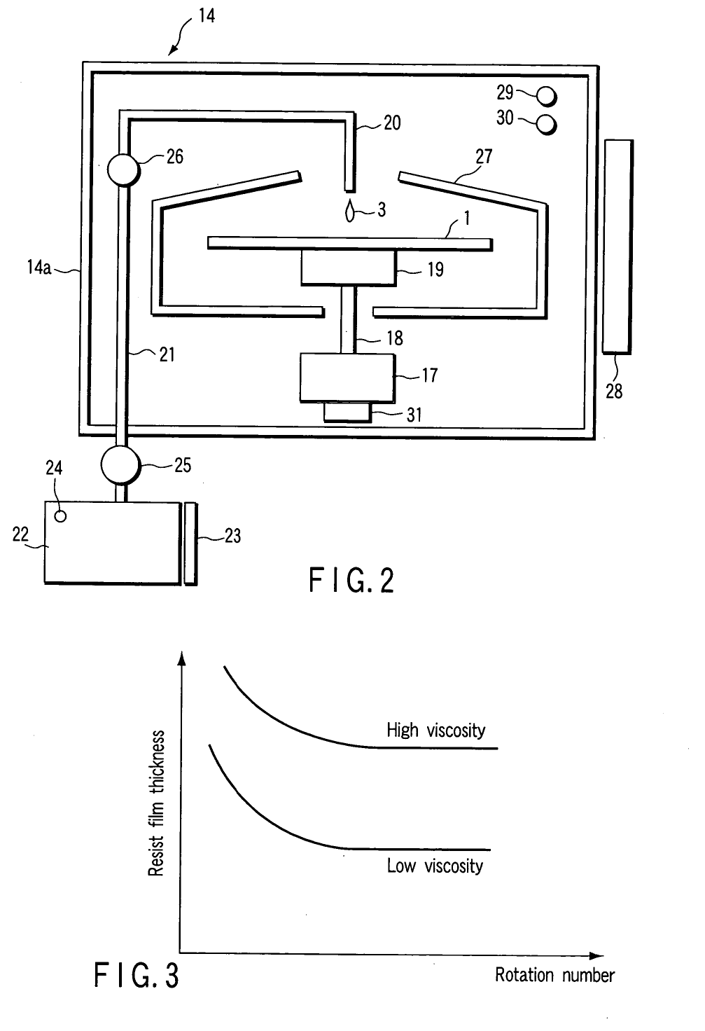

FIG. 2 is a constitution diagram of the coater 14. A motor 17 is disposed in a coater main body container 14a. A vacuum chuck 19 is disposed on a shaft 18 of the motor 17. The vacuum chuck 19 adsorbs/holds the semiconductor wafer 1.

A resist nozzle 20 is disposed above the semiconductor wafer 1. The resist nozzle 20 is connected to a photoresist tank 22 via a connection tube 21. A solution of the photoresist 3 is accommodated in the photoresist tank 22. The photoresist tank 22 is provided with a heater 23. The photoresist tank 22 includes therein a thermometer 24 which detects a temperature of the photoresist 3. The heater 23 is energized/controlled in such a manner as to set the solution temperature of the photoresist 3 detected by the thermometer 24 to a set temperature (constant temperature).

Viscosity of the photoresist 3 changes with the temperature. A rotation number of the coater 14 and the solution temperature of the photoresist are controlled in such a manner that a film thickness of the photoresist 3 formed on the surface of the semiconductor wafer 1 is a set film thickness from a relation between the rotation number of the motor 17 in the coater 14 and the viscosity of the photoresist 3 as shown in FIG. 3.

The connection tube 21 is connected to a pump 25 and a flow meter 26. The pump 25 sends a photoresist solution in the photoresist tank 22 to the resist nozzle 20. The flow meter 26 measures an amount of the solution of the photoresist 3 sent to the resist nozzle 20. The amount of the solution of the photoresist 3 sent by the pump 25 is controlled based on the solution amount detected by the flow meter 26. Accordingly, the amount of the solution of the photoresist 3 dropped onto the surface of the semiconductor wafer 1 from the resist nozzle 20 is controlled to be a predetermined amount.

A cup 27 is disposed in the periphery of the semiconductor wafer 1 adsorbed/held by the vacuum chuck 19 in such a manner as to surround the semiconductor wafer 1. The coater main body container 14a is provided with a heater 28. A thermometer 29 and a hygrometer 30 are disposed in the coater main body container 14a. The heater 28 is energized/controlled in such a manner as to set the temperature in the coater main body container 14a to a predetermined temperature (e.g., 20 to 25°) based on the temperature detected by the thermometer 29. A humidity in the coater main body container 14a is kept at a predetermined humidity (e.g., relative humidity of 40% or less) based on the humidity detected by the hygrometer 30. An adhesive property of the thin film of the photoresist 3 is prevented from being lowered by the humidity control.

A rotation number sensor 31 is attached to the motor 17. The motor 17 is controlled to have a predetermined rotation number based on the rotation number detected by the rotation number sensor 31. The film thickness of the photoresist 3 on the surface of the semiconductor wafer 1 is formed in a predetermined film thickness by rotation control of the motor 17.

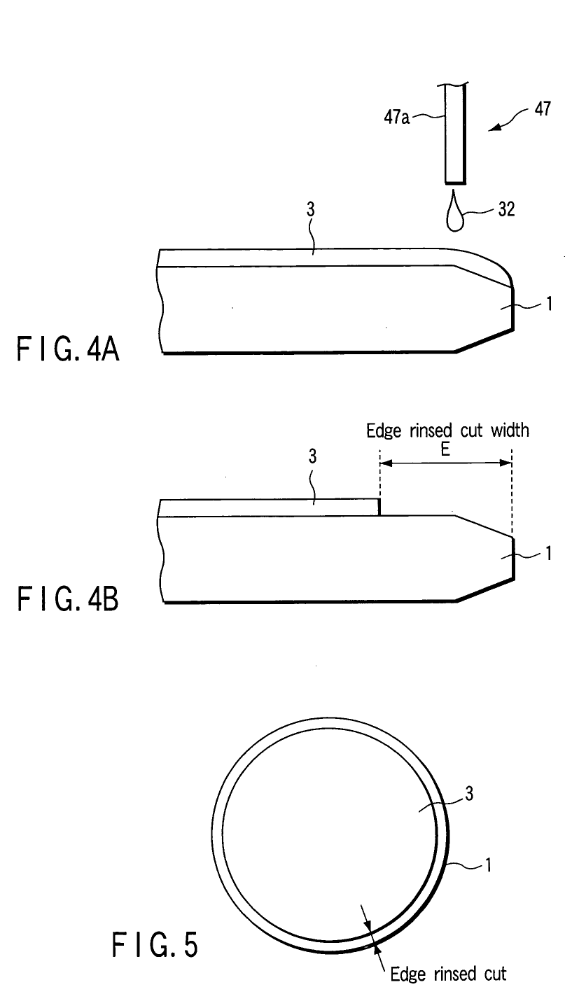

The coater 14 is provided with an edge rinsing cutter 47 shown in FIG. 4A. As shown in FIG. 5, the edge rinsing cutter 47 cuts the photoresist 3 of the outer peripheral edge of the semiconductor wafer 1 after the photoresist 3 is applied.

Concretely, a rinse nozzle 47a is disposed above the outer peripheral edge of the semiconductor wafer 1. The rinse nozzle 47a drops an appropriate amount of a rinsing solution 32 with respect to the outer peripheral edge of the photoresist 3. Accordingly, the photoresist 3 of the outer peripheral edge of the semiconductor wafer 1 is cut by a predetermined edge rinsed cut width E as shown in FIG. 4B.

In the coater 14, operation conditions of the coater 14, such as temperature, humidity, and a drop amount of the photoresist 3, and a rotation number and a rotation time of the semiconductor wafer 1 are controlled by the coater control section 14a.

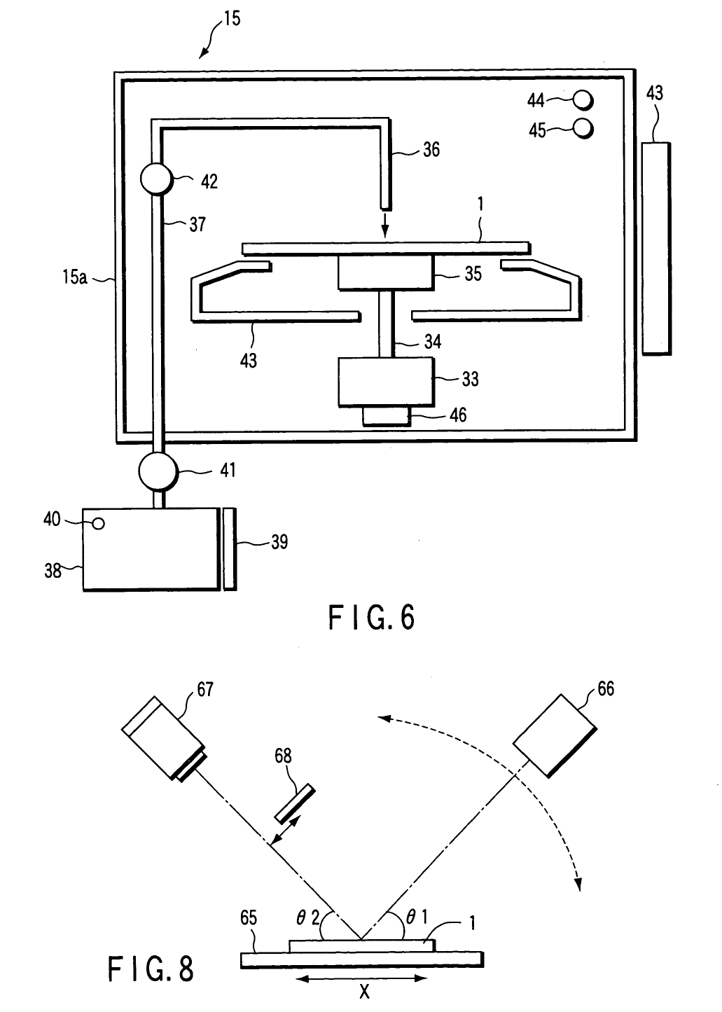

FIG. 6 is a constitution diagram of the developer 15. A motor 33 is disposed in a developer container 15a. A vacuum chuck 35 is disposed on a shaft 34 of the motor 33. The vacuum chuck 35 adsorbs/holds the semiconductor wafer 1.

A developing nozzle 36 is disposed above the semiconductor wafer 1. The developing nozzle 36 is connected to a developing solution tank 38 via a connection tube 37. A developing solution is contained in the developing solution tank 38. The developing solution tank 38 is provided with a heater 39. A thermometer 40 which detects a temperature of the developing solution is disposed in the developing solution tank 38. In the developing solution tank 38, the heater 39 is energized/controlled in such a manner as to set the temperature of the developing solution detected by the thermometer 40 to a set temperature.

The connection tube 37 is connected to a pump 41 and a flow meter 42. The pump 41 sends the developing solution in the developing solution tank 38 to the developing nozzle 36. The flow meter 42 measures the amount of the developing solution sent to the developing nozzle 36. The amount of the developing solution sent by the pump 41 is controlled based on the solution amount detected by the flow meter 42. Accordingly, the amount of the developing solution dropped on the surface of the semiconductor wafer 1 from the developing nozzle 36 is controlled to be a predetermined amount.

A cup 43 is disposed under the vacuum chuck 35. The developer container 15a is provided with a heater 43. A thermometer 44 and a hygrometer 45 are disposed in the developer container 15a. The heater 43 is energized/controlled based on the temperature detected by the thermometer 44. Accordingly, the temperature in the developer container 15a is controlled at a predetermined temperature. The humidity in the developer container 15a is kept at a predetermined humidity based on the humidity detected by the hygrometer 45.

A rotation number sensor 46 is attached to the motor 33. The rotation number of the motor 33 is controlled to be a predetermined rotation number based on the rotation number detected by the rotation number sensor 46. The developing solution uniformly flows on the surface of the semiconductor wafer 1 by the rotation control of the motor 33.

In the developer 15, the amount, temperature and the like of the developing solution dropped onto the surface of the semiconductor wafer 1 are controlled by the developer control section 15a.

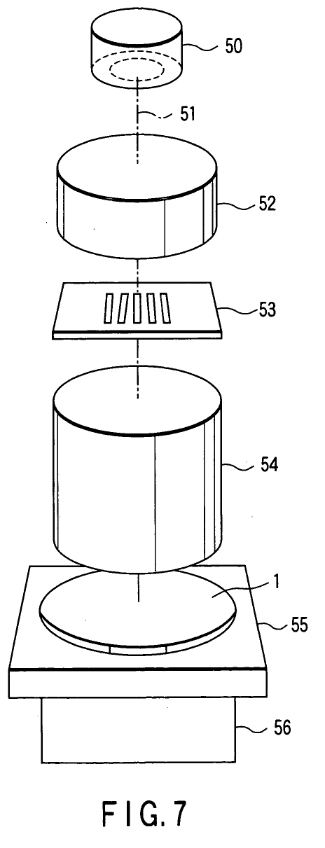

FIG. 7 is a schematic constitution diagram of the exposure unit 11. The exposure unit 11 is, for example, a stepper (reduced projection exposure unit). For example, a mercury lamp is used in a light source 50. On an optical axis 51 of the light source 50, a condenser lens 52, a photo mask substrate (hereinafter referred to as the mask) 53 on which a semiconductor pattern is formed, and a projection lens 54 are disposed. A stage 55 on which the semiconductor wafer 1 is laid is disposed on the optical axis 51. The stage 55 is movable in an XYZ direction by an XYZ tilting mechanism 56, and a tilt angle is also variable with respect to the Z-direction. In the exposure unit 11, the pattern formed on the mask 53 is reduced, for example, to 1/10, 1/5, 1/4 and the like, and projected onto the semiconductor wafer 1.

In the exposure unit 11, an exposure amount by the light source 50, a focus amount by an optical exposure system, tilt of the stage 55 and the like are controlled by an exposure control section 11a.

The reworking device 16 removes the pattern by the thin film 2 formed on the semiconductor wafer 1 in a case where a defect is generated in the semiconductor wafer 1 subjected to the applying of the resist by the coater 14, the transferring of the pattern by the exposure unit 11, and the developing by the developer 15.

The first inspection section 60 is disposed on a feeding line side on which the cassette 12 is disposed. The first inspection section 60 picks up an image of the semiconductor wafer 1 before the application of the photoresist 3 is applied to acquire image data Im₁.

The second inspection section 61 is disposed between the coater 14 and the exposure unit 11. The second inspection section 61 picks up an image of the semiconductor wafer 1 coated with the photoresist 3 to acquire image data Im₂.

The third inspection section 62 is disposed on a shipping line side on which the cassette 13 is disposed. The third inspection section 62 picks up an image of the semiconductor wafer 1 after the exposing/developing has been finished, to acquire image data Im₃.

FIG. 8 is a constitution diagram of the first to third inspection sections 60 to 62. The first to third inspection sections 60 to 62 have the same constitution. The semiconductor wafer 1 is laid on a stage 65. A linear illumination section 66 and an image pickup section 67 constituted of a line sensor camera and the like are disposed above the stage 65. The illumination section 66 is disposed in such a manner that an optical axis is tilted by a predetermined angle θ₁ with respect to the surface of the semiconductor wafer 1. The illumination section 66 applies linear illuminative light onto the surface of the semiconductor wafer 1. The illumination section 66 is rotatably disposed in such a manner that the tilt angle θ₁ with respect to the surface of the semiconductor wafer 1 can be adjusted in a predetermined range. The illumination section 66 can be fixed at the desired tilt angle θ₁ by an electrical or mechanical stopper.

The image pickup section 67 is disposed in such a manner that an optical axis is tilted by a predetermined angle θ₂ with respect to the surface of the semiconductor wafer 1. The image pickup section 67 picks up an image of diffracted light from the surface of the semiconductor wafer 1, generated by the illumination from the illumination section 66, line by line. The image pickup section 67 is fixed in a state in which the optical axis is tilted by the predetermined angle θ₂.

An interference filter 68 is detachably inserted with respect to an image pickup light path of the image pickup section 67. The interference filter 68 is inserted into the image pickup light path of the image pickup section 67, when an interference image of the surface of the semiconductor wafer 1 is picked up.

In the coater/developer 10, a transport robot Ra is disposed. The transport robot Ra takes out the semiconductor wafer 1 coated with the resist by the coater 14 to transfer the wafer to the exposure unit 11, and takes out the semiconductor wafer 1 exposed by the exposure unit 11 to transfer the wafer to the developer 15. Before the applying of the photoresist, after the applying of the photoresist, and after the exposing/developing, the transport robot Ra takes the semiconductor wafers 1 from the coater/developer 10 and exposure unit 11 to lay the wafers on the stages 65 of the first to third inspection sections 60 to 62, and removes the semiconductor wafers 1 from the stage 65 to return the wafers to lines after a surface defect inspection.

The shipping robot Rb is disposed outside the coater/developer 10, and takes the semiconductor wafer 1 judged to be discarded from the reworking device 16 to store the wafer in a cassette for discarding.

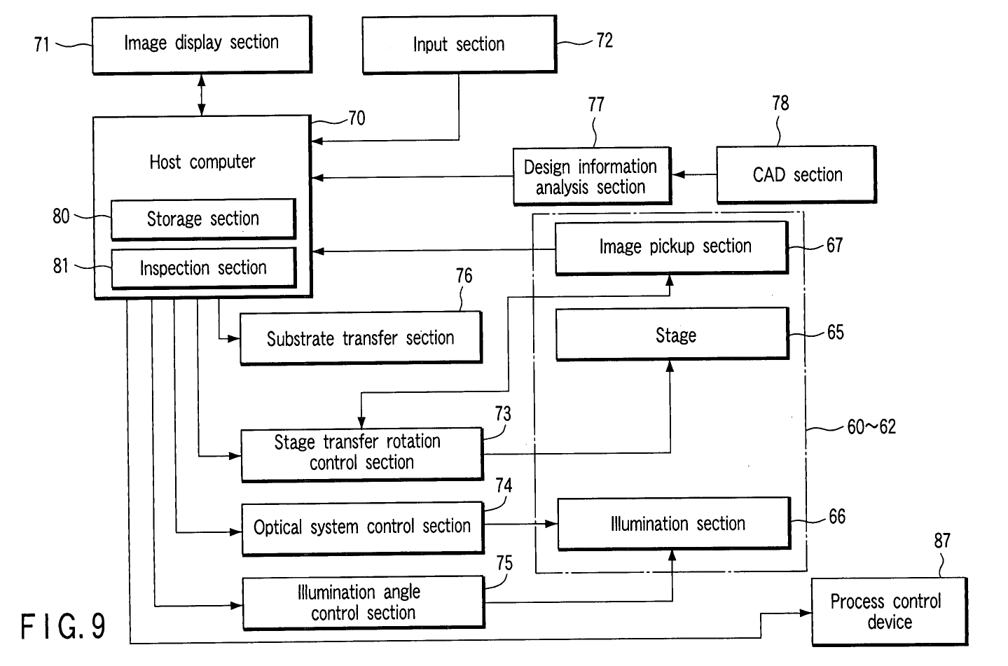

FIG. 9 is a constitution diagram of a surface defect inspection device 63. A host computer 70 is connected to the respective image pickup sections 67 in the first to third inspection sections 60 to 62. The host computer 70 issues operation commands to an image display section 71 such as a CRT display or a liquid crystal display, an input section 72, a stage transfer rotation control section 73, an optical system control section 74, an illumination angle control section 75, a substrate transport section 76, and a design information analysis section 77. The design information analysis section 77 is connected to a computer aided design (CAD) section 78 which holds design information for use in a chip designing step.

The host computer 70 prepares a graph showing a relation of a luminance value with respect to the tilt angle θ₁ of the illumination section 66 as shown in FIG. 10, and judges a position of an n-level light (primary light, secondary light) which is most suitable diffracted light for observation from the image data Im₁ to Im₃ acquired by the image pickup of the image pickup section 67 based on the graph.

The host computer 70 has a storage section 80 and an inspection process section 81. The storage section 80 stores the respective image data Im₁ to Im₃ acquired by the image pickup of the image pickup section 67, and information (defect information) of inspection results obtained by the inspection process section 81.

The inspection process section 81 receives the image data acquired by the image pickup of the respective image pickup sections 67 of the first to third inspection sections 60 to 62, that is, the image data Im₁ of the semiconductor wafer 1 before the photoresist 3 is applied, the image data Im₂ of the semiconductor wafer 1 after the photoresist 3 is applied, and the image data Im₃ of the semiconductor wafer 1 after the developing. The section analyzes the respective image data Im₁ to Im₃ to inspect the semiconductor wafers 1 after the applying of the resist, after the exposing, and after the developing.

The inspection section 81 obtains defect information after the applying of the resist, after the exposing process, and after the developing, such as types, numbers, positions, and areas of defects as inspection results with respect to the semiconductor wafers 1 to display the defect information in the image display section 71.

As shown in FIG. 11, the inspection process section 81 includes a resist process section 82, an exposing/developing process section 83, a step processing section 84, a cut width process section 85, and a master image processing section 86.

The resist process section 82 compares the image data Im₁ with Im₂ stored in the storage section 80 to obtain difference image data (Im₂−Im₁), detects foreign matters on the surface of the semiconductor wafer 1 from the difference image data (Im₂−Im₁), and further detects an applied state of the photoresist 3 from the difference image data (Im₂−Im₁).

The exposing/developing process section 83 compares the image data Im₃ stored in the storage section 80 with pre-stored image data (hereinafter referred to as the master image data) I_{Ref3} of the non-defective semiconductor wafer 1 after the developing to obtain difference image data (I_{Ref3}−Im₃), and performs an appearance inspection with respect to the semiconductor wafer 1 immediately after the manufacturing from the difference image data (I_{Ref3}−Im₃)

From the results of the appearance inspection with respect to the semiconductor wafer 1, the exposing/developing process section 83 detects a defocus, a mask difference, an excessively large or small masking blade, defects or foreign matters on the mask 53, and double-exposure or non-exposure with respect to the semiconductor wafer 1 in the exposure unit 11, or detects developing defects in the developer 15.

The step processing section 84 compares the image data Im₃ with Im₁ stored in the storage section 80 to obtain the difference image data (Im₃−Im₁), and inspects a treated state in a first photolithography step (photoresist applying, exposing/developing) from the difference image data (Im₃−Im₁).

The step processing section 84 sends the semiconductor wafer 1 which ends the photolithography step and which is inspected as defective to the reworking device 16, and sends the corrected semiconductor wafer 1 to the coater 14 again. The step processing section 84 stores a product number of the semiconductor wafer 1 thrown in the coater 14 again, and counts the number of inspections in which the wafer is regarded as defective.

The step processing section 84 judges that the semiconductor wafer 1 is to be rejected and that the wafer is to be removed from a photolithography step line, when the number of the inspections in which the wafer is regarded as defective is not less than a predetermined defect number.

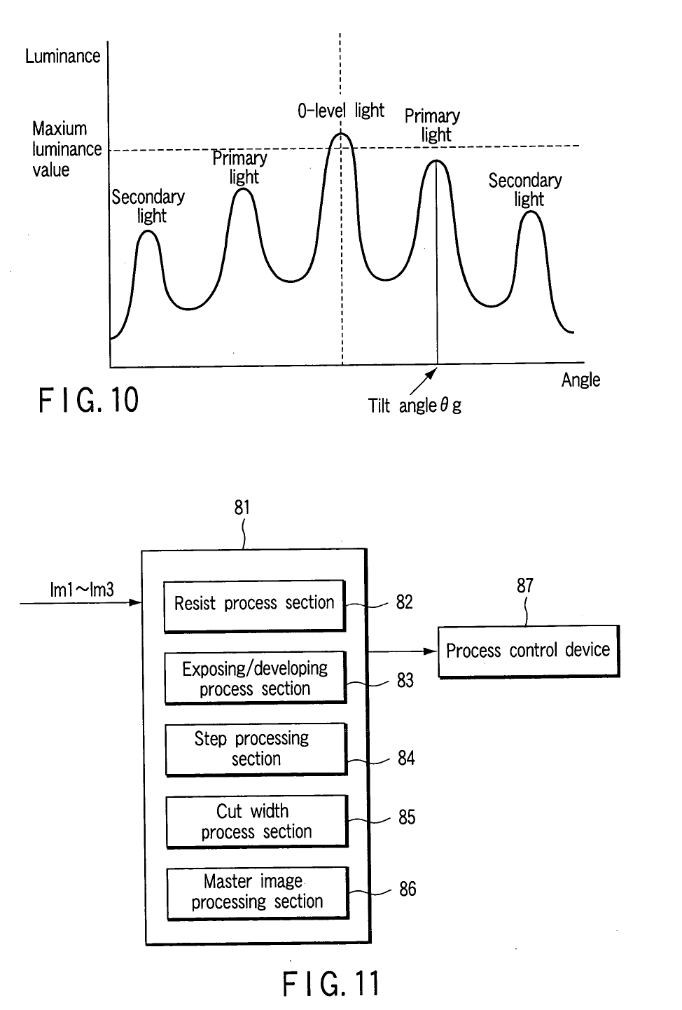

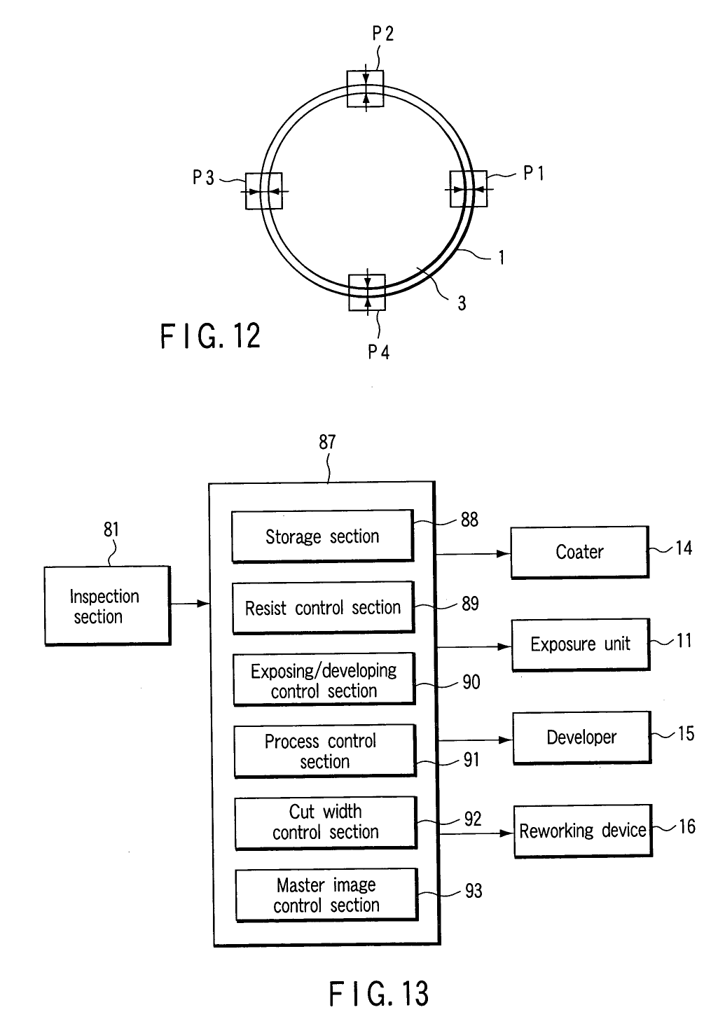

From the image data Im₂ stored in the storage section 80, the cut width process section 85 detects the edge rinsed cut width E shown in FIG. 4B in a plurality of places of a peripheral edge portion of the semiconductor wafer 1, such as four places P₁ to P₄ as shown in FIG. 12 to judge whether or not the edge rinsed cut width E satisfies a preset allowable width.

The cut width process section 85 detects defects such as chips and cracks in the edge portion from an edge image of a whole periphery of the peripheral edge portion of the semiconductor wafer 1 from the image data Im₂.

The master image processing section 86 reads master image data I_{Ref1} of the non-defective semiconductor wafer 1 before applying the photoresist 3, master image data I_{Ref2} of the non-defective semiconductor wafer 1 after applying the photoresist 3, and master image data I_{Ref3} of the non-defective semiconductor wafer 1 after the developing, stored beforehand in the storage section 80.

The master image processing section 86 obtains master difference image data (I_{Ref2}−I_{Ref1}) between the respective master image data I_{Ref2} and I_{Ref1} and detects the applied state of the photoresist 3 from difference image data (I_{Ref2}−I_{Ref1})−(Im₂−Im₁) between the master difference image data (I_{Ref2}−I_{Ref1}) and the difference image data (Im₂−Im₁).

Moreover, the master image processing section 86 obtains master difference image data (I_{Ref3}−I_{Ref1}) between the respective master image data I_{Ref3} and I_{Ref1}, inspects the treated state in the first photolithography step from difference image data (I_{Ref3}−I_{Ref1})−(Im₃−Im₁) between the master difference image data (I_{Ref3}−I_{Ref1}) and the difference image data (Im₃−Im₁), and detects non-defective wafers from the semiconductor wafers 1 after ending the first photolithography step.

A process control device 87 receives the inspection result of the inspection process section 81, and performs feedback controls of the coater 14, developer 15, and exposure unit 11 based on a result of comparison of the inspection result with operation conditions of the coater 14, developer 15, and exposure unit 11. As shown in FIG. 13, the process control device 87 has a storage section 88, a resist control section 89, an exposing/developing control section 90, a process control section 91, a cut width control section 92, and a master image control section 93.

The storage section 88 stores the respective operation conditions of the coater 14, developer 15, and exposure unit 11 to be feedback-controlled in accordance with the inspection result of the inspection process section 81. Examples of the operation conditions of the coater 14 include the temperature, the humidity, the drop amount of the photoresist 3, the rotation number and rotation time of the semiconductor wafer 1 and the like. The examples of the operation conditions of the developer 15 include the amount of the developing solution dropped onto the surface of the semiconductor wafer 1, the temperature and the like. The examples of the operation conditions of the exposure unit 11 include the exposure amount by the light source 50, the focus amount by the optical exposure system, the tilt of the stage 55, the number of the mask substrate and the like.

The resist control section 89 sends a feedback control signal to the coater control section 14a, which changes the operation conditions of the coater 14, for example, at least one of the temperature, the humidity, the drop amount of the photoresist 3 onto the semiconductor wafer 1, and the rotation number and the rotation time of the semiconductor wafer 1 in accordance with the inspection result of the applied state of the photoresist 3 on the surface of the semiconductor wafer 1 by the resist process section 82.

The exposing/developing control section 90 sends a feedback control signal to the exposure control section 11a or the developer control section 15a, which changes the operation conditions of either or both of the exposure unit 11 and the developer 15 in accordance with the appearance inspection result of the semiconductor wafer 1 by the exposing/developing process section 83.

The exposing/developing control section 90 sends a feedback control signal to the exposure control section 11a, which controls at least one of the exposure amount by the light source 50, the focus amount by the optical exposure system, and tilting to the XYZ tilting mechanism 56 for controlling the tilt of the stage 55 as the operation conditions of the exposure unit 11.

When the exposing/developing process section 83 detects the developing defect in the developer 15, the exposing/developing control section 90 sends a feedback control signal to the developer 15, to control at least one of the amount and the temperature of the developing solution dropped onto the surface of the semiconductor wafer 1 as the operation conditions of the developer 15.

The process control section 91 receives the inspection result of the semiconductor wafer 1 after ending the first photolithography step from the step processing section 84, detects the defective wafer from the semiconductor wafers 1 from the inspection result, then sends the semiconductor wafer 1 to the reworking device 16, and further sends a control signal to throw the wafer into the coater 14 again to the reworking device 16.

The process control section 91 sends a command to the shipping robot Rb to store the semiconductor wafer 1 into the cassette for the discarding in order to remove a reject substrate judged to be unable to be reworked by the inspection process section 81 or a reject substrate judged to be a defect exceeding a predetermined number of reworking times by the step processing section 84 from the photolithography step line.

The cut width control section 92 sends a cut width control signal to the coater control section 14a, which adjusts the drop amount of the rinsing solution in such a manner that the edge rinsed cut widths E in four places P₁ to P₄ detected by the cut width process section 85 as shown in FIG. 12 are within allowable ranges.

When it is judged that the edge rinsed cut width E does not satisfy a preset allowable width, the cut width control section 92 throws the defective semiconductor wafer 1 into the reworking device 16 again.

The master image control section 93 receives the applied state of the photoresist 3 detected by the master image processing section 86, and sends a feedback control signal to the coater main body container 14a, which changes the operation conditions of the coater 14, for example, at least one of the temperature, the humidity, the drop amount of the photoresist 3 onto the semiconductor wafer 1, and the rotation number and the rotation time of the semiconductor wafer 1 in accordance with the applied state of the photoresist 3.

When it is judged that the wafer can be reworked and is defective by a final inspection result of the first photolithography step detected by the master image processing section 86, the master image control section 93 sends the semiconductor wafer 1 to the reworking device 16, and sends a command to the reworking device 16 and the coater control section 14a to throw the wafer into the coater 14 again.

It is to be noted that the respective inspection sections 60 to 62 are disposed before/after the coater 14, exposure unit 11, and developer 15, but one of the inspection sections may be disposed in the coater/developer 10, and transported among the coater 14, exposure unit 11, and developer 15 by a transport robot or the like.

A fourth inspection section 94 may be disposed between the exposure unit 11 and the developer 15. The fourth inspection section 94 acquires image data Im₄ of the semiconductor wafer 1 subjected to the exposing process.

The inspection process section 81 obtains difference image data (Im₄−Im₂) between the image data Im₄ and Im₂, and detects at least one of the defocus, mistaken mask, excessively large or small masking blade of the mask 53, defects or foreign matters on the mask 53, and double-exposure or non-exposure with respect to the semiconductor wafer 1 in the exposure unit 11 from the difference image data (Im₄−Im₂).

The stage transfer rotation control section 73 moves/controls the stage 65 on which the semiconductor wafer 1 is laid in a direction intersecting with a longitudinal direction of linear illumination by the illumination section 66 at a pitch synchronized with the image pickup in the image pickup section 67.

The stage transfer rotation control section 73 rotates/controls and positions/controls the stage 65. To rotate the semiconductor wafer 1, the stage 65 itself is rotated. A rotary stage is preferably disposed on the stage 65 movable along a single axis, and rotated. Moreover, an orientation flat position or a notch of the rotating semiconductor wafer 1 is detected by a sensor, and the rotary stage or the like is stopped based on the orientation flat position or the notch position to position the semiconductor wafer 1 in a predetermined posture.

When the interference image is acquired, the optical system control section 74 inserts the interference filter 68, or controls a quantity of light of the illumination section 66.

The illumination angle control section 75 controls the tilt angle of the illumination by the illumination section 66 with respect to the surface of the semiconductor wafer 1 in accordance with an instruction of the host computer 70.

The substrate transport section 76 controls the operation of the transport robot Ra, receives the semiconductor wafer 1 to lay the wafer on the stage 65 before the applying of the photoresist, after the applying of the photoresist, and after the exposing/developing, and receives the semiconductor wafer 1 on the stage 65 to return the wafer to the line after the surface defect inspection.

Next, a function of the apparatus constituted as described above will be described.

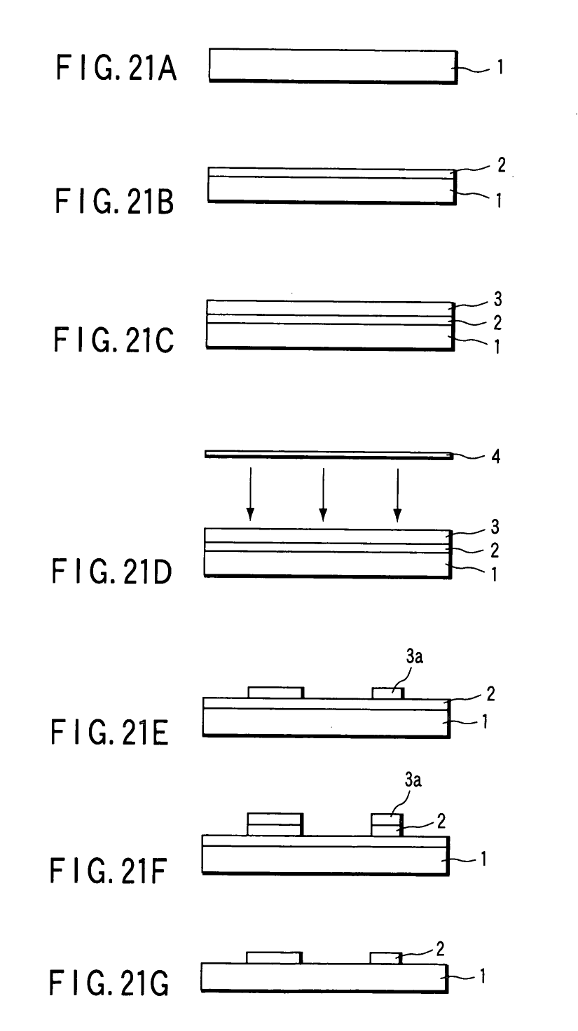

As shown in FIG. 21B, a plurality of semiconductor wafers 1 on which the thin films 2 are deposited as shown in FIG. 21B are stored in the cassette 12. The cassette 12 is set in the send-in port of the coater/developer 10 shown in FIG. 1. When the semiconductor wafers 1 stored in the cassette 12 are thrown in the coater/developer 10 wafer by wafer, the semiconductor wafer 1 is transported into the coater 14 shown in FIG. 2 by the transport robot Ra.

The semiconductor wafer 1 is adsorbed/held onto the vacuum chuck 19 in the coater 14. The solution of the photoresist 3 stored in the photoresist tank 22 is sent to the resist nozzle 20 by a predetermined amount by an operation of the pump 25, and dropped onto a substantially middle portion of the surface of the semiconductor wafer 1.

Next, when the semiconductor wafer 1 rotates at a high speed by the driving of the motor 17, the thin film of the photoresist 3 is applied onto the surface of the semiconductor wafer 1.

Next, as shown in FIG. 4A, the edge rinsing cutter 47 drops an appropriate amount of the rinsing solution 32 onto the outer peripheral edge of the photoresist 3 from the rinse nozzle 47a as shown in FIG. 4A. Accordingly, the photoresist 3 of the outer peripheral edge of the semiconductor wafer 1 is cut by a predetermined width as shown in FIG. 4B.

Next, the semiconductor wafer 1 is transported into the exposure unit 11 by the transport robot Ra, and laid on the stage 55 as shown in FIG. 7. When exposure light is emitted from the light source 50, the pattern formed on the mask 53 is reduced/projected, for example, in a size of 1/10, 1/5, 1/4 or the like, onto the surface of the semiconductor wafer 1. When the exposing ends, the semiconductor wafer 1 is transported into the developer 15 shown in FIG. 6 by the transport robot Ra.

The semiconductor wafer 1 is adsorbed/held by the vacuum chuck 35 in the developer 15. By the operation of the pump 41, the developing solution stored in the developing solution tank 38 is fed out to the developing nozzle 36 by the predetermined amount, and dropped on the substantially middle portion on the surface of the semiconductor wafer 1. Moreover, when the motor 33 is driven to thereby rotate the semiconductor wafer 1 at a high speed, the developing solution is passed onto the surface of the semiconductor wafer 1 to perform the developing process. Accordingly, in a positive type, the photoresist 3 of the exposed portion is dissolved, and the resist pattern 3 of the non-exposed portion is left. In a negative type, the photoresist 3 of the exposed portion is left, and the resist pattern 3 of the non-exposed pattern is dissolved.

In a series of step processes in the coater/developer 10 and the exposure unit 11, the first to third inspection sections 60 to 62 shown in FIG. 8 acquire the respective image data Im₁ to Im₃ of the semiconductor wafer 1 before the applying of the photoresist, after the applying of the photoresist, and after the exposing/developing.

The substrate transport section 76 shown in FIG. 9 takes the semiconductor wafer for setting the angle of the diffracted light from a stock to lay the wafer on the stage 1. The stage transfer rotation control section 73 positions the stage 1 on which the semiconductor wafer for setting the angle is laid.

The host computer 70 sets an irradiation position of the illumination section 66 on the semiconductor wafer. The illumination angle control section 75 sets the tilt angle of the illumination section 66 with respect to the surface of the semiconductor wafer to an initially set angle (rotation start position), and changes the tilt angle of the illumination section 66 from the initially set angle.

The image pickup section 67 takes in the diffracted light from the surface of the semiconductor wafer for each tilt angle, and sends data of the diffracted light to the host computer 70.

The host computer 70 obtains an average value of luminance values of the diffracted light data taken from the image pickup section 67 for each tilt angle of the illumination section 66, and obtains the luminance value corresponding to each tilt angle from the average luminance value. Moreover, the host computer 70 prepares a graph showing a relation between the luminance value and the angle shown in FIG. 10 from the diffracted light data, and judges the position of the n-level light most suitable for observation in the diffracted light whose image is picked up by the image pickup section 67 from the graph.

The illumination angle control section 75 sets an angle θg judged by the host computer 70 as the tilt angle θg of the illumination section 66 with respect to the semiconductor wafer. The tilt angle of the illumination section 66 is set for each type of the semiconductor wafer 1 and further for each manufacturing step of the semiconductor wafer 1. Moreover, when the surface defect inspection is performed with respect to the semiconductor wafer 1 of the same type in the same step, the tilt angle stored in the storage section 80 is used.

In a state in which the illumination section 66 is set to the optimum tilt angle θg, the surface defect inspection is performed with respect to the semiconductor wafer 1 before the applying of the photoresist, after the applying of the photoresist, and after the exposing/developing, respectively.

In the first inspection section 60, the substrate transport section 76 lays the semiconductor wafer 1 on the stage 65. The stage transfer rotation control section 73 moves the stage 65 in one direction (X-direction) at a constant speed. Synchronously, the image pickup section 67 picks up an image of the diffracted light for each line in a direction crossing a moving direction of the stage 1 at right angles. The diffracted image data picked up by the image pickup section 67 is transferred to the inspection process section 81 until scanning of the whole surface of the semiconductor wafer 1 ends.

When the picking-up of the diffracted image ends with respect to the whole surface of the semiconductor wafer 1, the optical system control section 74 inserts the interference filter 68 into the image pickup light path as shown in FIG. 8, and further controls a quantity of light of the illumination section 66 to be optimum. The illumination angle control section 75 sets the tilt angle of the illumination section 66 with respect to the surface of the semiconductor wafer 1 to an angle optimum for picking up the interference image. The stage transfer rotation control section 73 moves/controls the stage 65 in a direction opposite to that at a time when the diffracted image is picked up at the constant speed. Synchronously, the image pickup section 67 picks up an image of interference light for each line in a direction crossing the moving direction of the stage 65 at right angles. Interference image data picked up by the image pickup section 67 is transferred to an image analysis section 79 until the scanning of the whole surface of the semiconductor wafer 1 ends.

The diffracted image data and the interference image data acquired before the applying of the photoresist are stored as the image data Im₁ in the storage section 80.

When the picking-up of the diffracted image and the interference image ends with respect to the whole surface of the semiconductor wafer 1, the inspection process section 81 analyzes/processes the diffracted image data and the interference image data, extracts defects such as film thickness unevenness, dust, and damage on the surface of the semiconductor wafer 1 before the photoresist step, and displays defect information such as types, numbers, positions, and areas of the defects in the image display section 71. The inspection process section 81 classifies the extracted defect information for each type of the defect, and stores the information in the storage section 80.

Also in the second inspection section 61, the diffracted image data and the interference image data are similarly acquired with respect to the whole surface of the semiconductor wafer 1 coated with the photoresist, and are stored as the image data Im₂ in the storage section 80. The inspection process section 81 analyzes/processes the image data Im₂ to extract defects such as film thickness unevenness, dust, and damage on the surface of the semiconductor wafer 1 coated with the photoresist.

Also in the third inspection section 62, the diffracted image data and the interference image data are similarly acquired with respect to the whole surface of the semiconductor wafer 1 after the developing, and stored as the image data Im₃ in the storage section 80. The inspection process section 81 analyzes/processes the image data Im₃ to extract the defects of the resist pattern, dust, damage and the like on the surface of the semiconductor wafer 1 subjected to the exposing/developing process.

Next, the resist process section 82 judges whether or not the applied state of the photoresist 3 is satisfactory from the difference image data (Im₂−Im₁) between the respective image data Im₁ and Im₂.

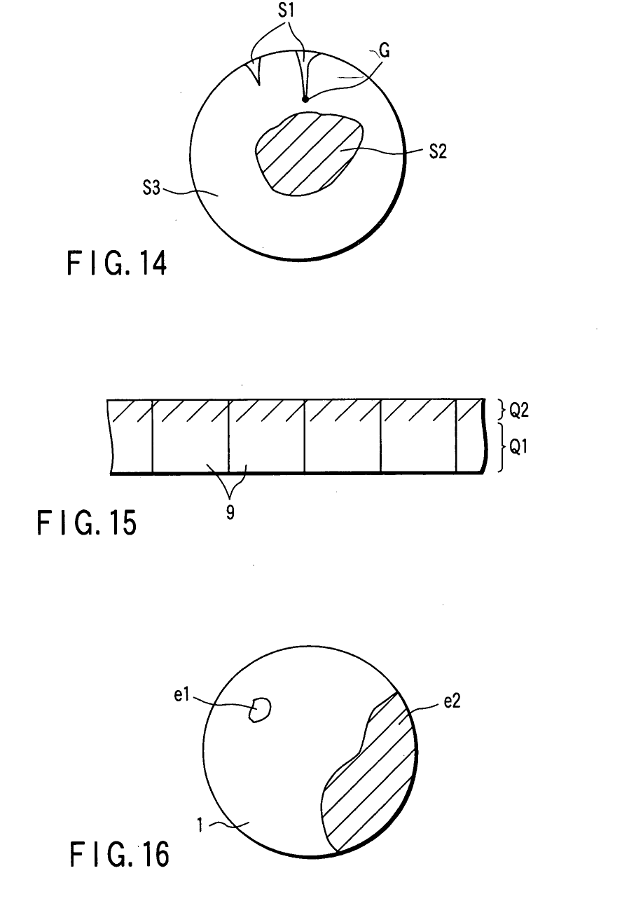

When the applied state of the photoresist 3 is defective, for example, as shown in FIG. 14, portions s₁ to which the photoresist 3 is not applied, a portion s₂ whose photoresist film thickness is larger than a predetermined film thickness, a portion s₃ whose photoresist film thickness is smaller than the predetermined film thickness and the like appear. In the portions s₁ to which the photoresist 3 is not applied, the solution of the photoresist 3 does not flow because of foreign matters G, and the portions s₁ to which the photoresist 3 is not applied are sometimes generated.

The resist control section 89 receives the judgment as to whether or not the applied state of the photoresist 3 is satisfactory from the resist process section 82, and changes the operation conditions of the coater 14, for example, at least one of the temperature, the humidity, the drop amount of the photoresist 3 onto the semiconductor wafer 1, and the rotation number and the rotation time of the semiconductor wafer 1 in accordance with the applied state of the photoresist 3.

Next, the edge rinsing cutter 47 drops an appropriate amount of the rinsing solution 32 with respect to the outer peripheral edge of the photoresist 3, and cuts the photoresist 3 by the predetermined edge rinsed cut width E as shown in FIG. 4B.

The cut width process section 85 detects the edge rinsed cut width E shown in FIG. 4B in four places P₁ to P₄ as shown in FIG. 12 from the image data Im₂. When the edge rinsed cut widths E are not in the allowable ranges, the cut width control section 92 adjusts the drop amount of the rinsing solution in the edge rinsing cutter 47 in such a manner that the respective edge rinsed cut widths E in four places P₁ to P₄ are in the allowable ranges, respectively.

Next, the exposing/developing process section 83 processes the image of the difference image data (I_{Ref3}−Im₃) between the developed image data Im₃ and the pre-stored image data I_{Ref3} of the non-defective semiconductor wafer 1 after the developing to detect the defocus.

Moreover, the exposing/developing process section 83 detects the mistaken mask, the masking blade, the defects or the foreign matters on the mask 53, the double exposure, and the non-exposure from the difference image data (I_{Ref3}−Im₃).

On receiving the inspection result of the exposing/developing process section 83, the exposing/developing control section 90 sends a feedback control signal to the exposure control section 11a, which controls, for example, at least one of the exposure amount of the exposure unit 11 by the light source 50 and the focus amount by the optical exposure system.

Moreover, on receiving the result of the developing defect in the developer 15 from the exposing/developing process section 83, the exposing/developing control section 90 sends a feedback control signal to the developer control section 15a, which controls at least one of the amount and the temperature of the developing solution dropped onto the surface of the semiconductor wafer 1 in the developer 15.

Moreover, the exposing/developing process section 83 processes the image of the difference image data (I_{Ref3}−Im₃), detects that a portion Q₁ having a uniformly large exposure amount and a portion Q₂ having a small amount appear in an exposed state for each chip on the semiconductor wafer 1 as shown in FIG. 15, and then judges that the semiconductor wafer 1 tilts together with the stage 55.

On receiving a judgment result indicating that the semiconductor wafer 1 tilts from the exposing/developing process section 83, the exposing/developing control section 90 sends a control signal which controls the tilting of the XYZ tilting mechanism 56 to the exposure control section 11a.

Furthermore, the exposing/developing process section 83 processes the image of the difference image data (I_{Ref3}−Im₃), and detects portions e₁, e₂ of the developing defects in the developer 15 shown in FIG. 16. On receiving the portions e₁, e₂ of the developing defects from the exposing/developing process section 83, the exposing/developing control section 90 sends a feedback control signal of at least one of the amount and the temperature of the developing solution dropped onto the surface of the semiconductor wafer 1 in the developer 15 to the developer control section 15a.

The step processing section 84 inspects the treated state of the first photolithography step from the difference image data (Im₃−Im₁), receives the inspection result or an inspection result (master difference image data) of the treated state in the first photolithography step by the master image processing section 86, and detects a non-defective wafer, a reworkable defective wafer, or a non-reworkable reject substrate with respect to the semiconductor wafer 1 from these inspection results. On detecting the reworkable defective wafer from the semiconductor wafers 1, the step processing section 84 sends an instruction to correct the defective semiconductor wafer 1 to the reworking device 16.

The reworking device 16 removes the resist pattern 3a formed on the reworkable defective semiconductor wafer 1, and sends the semiconductor wafer 1 to the coater 14 again.

The step processing section 84 stores a product number of the semiconductor wafer 1 sent to the coater 14 again, and counts the number of times when the wafer is judged to be defective. When the number of judgments indicating that the wafer is defective is not less than a predetermined defect number, the semiconductor wafer 1 is judged to be a reject, and it is judged that the wafer is to be removed from the photolithography step line. Then, the shipping robot Rb stores the semiconductor wafer 1 judged to be discarded into the cassette for the discarding.

The master image processing section 86 detects the applied state of the photoresist 3 from the difference image data (I_{Ref3}−I_{Ref1})−(Im₂−Im₁) in the same manner as described above. The master image control section 93 changes the operation conditions of the coater 14, for example, at least one of the temperature, the humidity, the drop amount of the photoresist 3 onto the semiconductor wafer 1, and the rotation number and the rotation time of the semiconductor wafer 1 in accordance with the applied state detected by the master image processing section 86.

Moreover, the master image processing section 86 outputs the inspection result of the treated state in the first photolithography step from the difference image data (I_{Ref3}−I_{Ref1})−(Im₃−Im₁) in the same manner as described above.

Next, calibration of the apparatus of the present invention will be described.

In the calibration of the apparatus, one to several standard semiconductor wafers are periodically passed. When the standard semiconductor wafer passes through the respective steps of the photoresist applying, exposing, and developing, the respective image data Im₁ to Im₃ are acquired before the applying of the photoresist, after the applying of the photoresist, and after the exposing/developing.

The resist process section 82 detects the applied state of the photoresist 3 from the comparison result of the image data Im₁ with Im₂, and sends the detection result to the resist control section 89. The resist control section 89 changes at least one of the operation conditions of the coater 14 in accordance with the applied state to perform the feedback control. Accordingly, the coater 14 is calibrated.

The cut width process section 85 detects the edge rinsed cut widths E in four places P₁ to P₄ from the image data Im₂. The cut width control section 92 controls the drop amount of the rinsing solution in the coater 14 in such a manner that the respective edge rinsed cut widths E in four places P₁ to P₄ are in the allowable ranges, respectively. Accordingly, the edge rinsed cut widths E are calibrated.

The exposing/developing control section 90 inspects the appearance of the semiconductor wafer 1 from the difference image data (I_{Ref3}−Im₃) in the same manner as described above. The exposing/developing control section 90 feedback-controls the operation conditions of either or both of the exposure unit 11 and the developer 15 in accordance with the appearance inspection result of the exposing/developing process section 83. Accordingly, the exposure unit 11 is calibrated with respect to the exposure amount by the light source 50, the focus amount by the optical system and the like. In the developer 15, a capacity of the developing solution, temperature and the like are calibrated.

Moreover, the exposing/developing process section 83 processes the image of the difference image data (I_{Ref3}−Im₃) to thereby detect that the portion Q₁ having a large exposure amount and the portion Q₂ having a small amount appear as shown in FIG. 14, and then judges that the semiconductor wafer 1 tilts together with the stage 55. The exposing/developing control section 90 feedback-controls the tilting into the XYZ tilting mechanism 56 for controlling the tilt of the stage 55 with respect to the exposure unit 11 to calibrate the XYZ tilting mechanism 56.

Thus, according to the first embodiment, the respective processing results before the applying of the photoresist, after the applying of the photoresist, and after the exposing/developing are inspected from the image data Im₁ to Im₃ (Im₄) acquired by the first to third (fourth) inspection sections 60 to 62 (69), and the operation conditions of the coater 14, exposure unit 11, or developer 15 are individually feedback-controlled in accordance with the inspection result. Accordingly, the conditions of the respective steps of the photoresist applying, exposing, and developing are variably set to thereby make possible stable semiconductor manufacturing.

The respective inspections before the applying of the photoresist, after the applying of the photoresist, and after the exposing/developing are performed based on the difference image data (Im₂−Im₁) between the image data Im₁ and Im₂, the difference image data (I_{Ref3}−Im₃) between the image data Im₃ and the master image data I_{Ref3}, the difference image data (Im₃−Im₁) between the image data Im₃ and Im₁, the difference image data (I_{Ref2}−I_{Ref1})−(Im₂−Im₁), and the difference image data (I_{Ref3}−I_{Ref1})−(Im₃−Im₁). Accordingly, the respective treated states of the photoresist applying and the developing in the coater/developer (C/D) 10 can be completely and accurately inspected, and optimum feedback control can be performed with respect to the coater/developer (C/D) 10 in accordance with the inspection result.

The step processing section 84 detects the non-defective or reworkable defective wafers among the semiconductor wafers 1 from the inspection result of the treated state in the first photolithography step, and the defective semiconductor wafer 1 is restored in the reworking device 16. Accordingly, the semiconductor wafer 1 which has been defective in the treatment in the first photolithography step is again subjected to the photolithography treatment, the non-defective semiconductor wafer 1 can be obtained, and useless semiconductor wafers 1 can be decreased.

Furthermore, when the number of inspections indicating that the wafer is defective is not less than the predetermined defect number, the defective semiconductor wafer 1 is judged to be a reject, it is judged that the semiconductor wafer 1 itself has a problem, and the wafer can be discarded.

The surface defect inspections of the semiconductor wafer 1 before the applying of the photoresist, after the applying of the photoresist, and after the exposing/developing can be performed in line in a semiconductor manufacturing apparatus constituted of the coater/developer (C/D) 10 and the exposure unit 11. Moreover, the operation conditions of the coater 14, exposure unit 11, and developer 15 can be feedback-controlled based on the surface defect inspection results of the semiconductor wafer 1.

Moreover, the treatment state in the whole first photolithography step can be inspected from the difference image data (Im₃−Im₁) between the image data Im₃ and Im₁.

By the comparison of the inspection result after the applying of the photoresist with the inspection result after the exposing/developing, any defect is not detected from the inspection result after the applying of the photoresist, the defect is detected from the inspection result after the exposing/developing, and then it becomes clear that a cause for generation of the defect lies in the step of the exposing/developing.

By the image analyzing/processing of the respective image data Im₁ to Im₃, defects such as film thickness unevenness, dust, and damage on the surface of the semiconductor wafer 1 in the respective steps of the photoresist applying and the exposing/developing can be detected in line, and information such as types, number, positions, and areas of the defects can be acquired in line.

When one to several standard semiconductor wafers are periodically passed, the temperature and humidity in the coater 14, the solution temperature of the photoresist 3 in the photoresist tank 22, the drop amount of the photoresist 3, and the rotation number and rotation time of the motor 17 can be calibrated. The drop amount of the rinsing solution in the edge rinsing cutter 47, the exposure amount by the light source 50 in the exposure unit 11, the focus amount by the optical system, the tilting into the XYZ tilting mechanism 56, the capacity and temperature of the developing solution in the developer 15 and the like can be automatically calibrated.

Next, a second embodiment of the present invention will be described with reference to the drawings. It is to be noted that the same parts as those of FIG. 1 are denoted with the same reference numerals, and detailed description thereof is omitted.

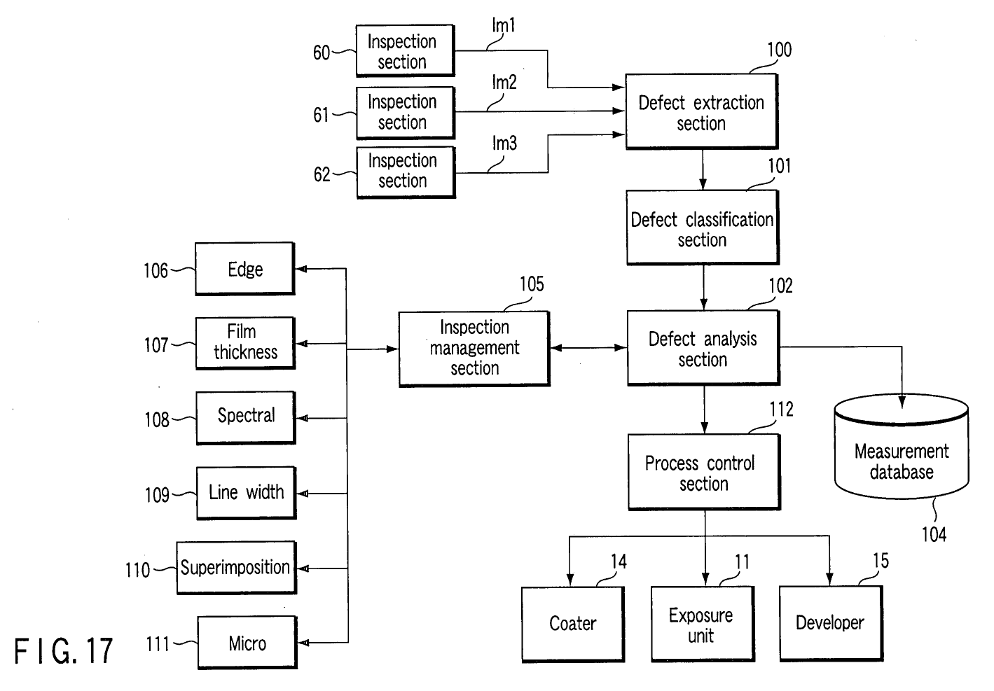

FIG. 17 is a constitution diagram of a semiconductor manufacturing apparatus. A defect extraction section 100 takes in image data Im₁ to Im₃ acquired by the first to third inspection sections 60 to 62, respectively, and extracts defects on a semiconductor wafer 1 before the applying of a photoresist, after the applying of the photoresist, and after the exposing/developing based on the respective image data Im₁ to Im₃.

A defect classification section 101 obtains the following characteristic amounts of defect portions on the semiconductor wafer 1 extracted by the defect extraction section 100:

a: a characteristic amount which depends on one shot at a time when the shot of exposure light is reduced/projected onto the surface of the semiconductor wafer 1 through a mask 53 in an exposure unit 11;

b: a characteristic amount which depends on tilt of one shot at a time when the shot of exposure light is reduced/projected onto the surface of the semiconductor wafer 1 in the exposure unit 11;

c: a characteristic amount which depends on a case where the exposure light is continuously applied in the exposure unit 11, a characteristic amount which depends on missing of the exposure light to be applied onto the surface of the semiconductor wafer 1;

d: a characteristic amount which depends on a case where any exposure light is not applied to the whole surface of the semiconductor wafer 1 in the exposure unit 11;

e: a characteristic amount which depends on an abnormality around the shot such as chipping of a pattern at a time when the exposure light is applied onto the surface of the semiconductor wafer 1 in the exposure unit 11;

f: a characteristic amount which depends on a case where a mask pattern reduced/projected onto the surface of the semiconductor wafer 1 differs in the exposure unit 11;

g: a characteristic amount which depends on sagging of the pattern in a developing process;

h: a characteristic amount indicating a change of diffracted light from the semiconductor wafer 1 at a time when diffracted image data is acquired in the first to third inspection sections 60 to 62;

i: a characteristic amount indicating an abnormality of the diffracted light from the semiconductor wafer 1 at a time when the diffracted image data is acquired in the first to third inspection sections 60 to 62;

j: a characteristic amount indicating an abnormality of interference light from the semiconductor wafer 1 at a time when interference image data is acquired in the first to third inspection sections 60 to 62;

k: a characteristic amount which depends on unevenness or concave/convex shape on a circumferential edge of the semiconductor wafer 1;

l: a characteristic amount which depends on a circle center shape appearing on the surface of the semiconductor wafer 1;

m: a characteristic amount which depends on an elongated shape appearing on the surface of the semiconductor wafer 1;

n: a characteristic amount which depends on a rhombic shape appearing on the surface of the semiconductor wafer 1;

o: a characteristic amount which depends on a normal pattern on the surface of the semiconductor wafer 1 after the exposing or the developing;

p: a characteristic amount which depends on a rotation unevenness in a coater 14;

q: a characteristic amount which depends on an abnormality of a whole surface different from that of the semiconductor wafer 1 in a case where the whole surface of the semiconductor wafer 1 is non-defective; and the like.

A defect analysis section 102 receives the characteristic amount of the defect portion obtained by the defect classification section 101, and analyzes the type of the defect portion from the characteristic amount. One example of the analysis of the type of the defect portion is as follows.

a: It is judged that the defect portion is a defocus from the respective dependent characteristic amounts of the dependence on the shot, diffracted light change, pattern sagging, exposure amount and the like.

b: It is judged that the defect portion is a tilt abnormality from the dependent characteristic amounts of the dependence on the shot, tilt of the shot, continuance of exposure light and the like.

c: It is judged that the defect portion is non-exposure from the respective dependent characteristic amounts of shot missing, whole surface error and the like.

d: It is judged that the defect portion is a masking plate mistake from the respective dependent characteristic amounts of the shot periphery abnormality, pattern chipping and the like.

e: It is judged that the defect portion is an alignment mistake from the respective dependent characteristic amounts of the dependence on the shot, interference abnormality, diffraction abnormality and the like.

f: It is judged that the defect portion is a mask mistake from the respective dependent characteristic amounts of the different pattern, whole surface abnormality and the like.

g: It is judged that the defect portion is an application unevenness from the respective characteristic amounts which depend on the unevenness or the concave/convex shape of the circumferential edge of the semiconductor wafer 1.

h: It is judged that the defect portion is excessively little resist application from the respective characteristic amounts which depend on the unevenness on the circumferential edge of the semiconductor wafer 1 and the circle center shape appearing on the surface.

i: It is judged that the defect portion is abnormality unevenness from the respective characteristic amounts which depend on the circle center shape and the elongated shape appearing on the surface of the semiconductor wafer 1.

j: It is judged that the defect portion is a developing defect from the respective characteristic amounts which depend on the rhombic shape appearing on the surface of the semiconductor wafer 1 and the whole surface abnormality.

k: It is judged that the defect portion is excessive baking from the respective characteristic amounts which depend on the whole surface abnormality and the pattern normality.

l: It is judged that the defect portion is resist difference from the characteristic amount which depends on the whole surface abnormality.

m: It is judged that the defect portion is an excessively large viscosity of the resist from the characteristic amount which depends on a rotation unevenness and the like.

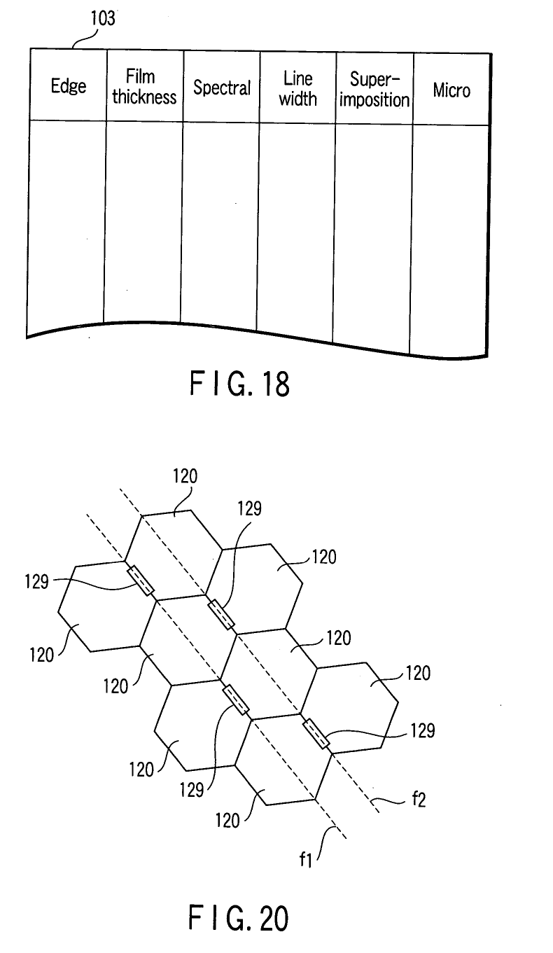

The defect analysis section 102 selects an optimum inspection method for measuring the type of the analyzed defect portion in detail using an inspection method selection table 103 shown in FIG. 18. In the inspection method selection table 103, the type of the defect portion is written with respect to edge inspection, film thickness inspection, spectral inspection, line width inspection, superimposition inspection, and micro inspection, respectively.

In the edge inspection, the defect portions, for example, the application unevenness, excessively little application, masking plate mistake and the like are described. In the film thickness inspection, the defect portions, for example, the alignment mistake, application unevenness, excessively little application, excessively much application and the like are described. Therefore, when the type of the defect portion is, for example, the application unevenness, the defect analysis section 102 selects the edge inspection from the inspection method selection table 103.

The defect analysis section 102 stores the characteristic amount of the defect portion received from the defect classification section 101 in a measurement database 104, and stores the type of the defect portion or the selected inspection method as an analysis result in the measurement database 104. The defect analysis section 102 stores measurement data obtained by the edge inspection, film thickness inspection, spectral inspection, line width inspection, superimposition inspection, and microinspection into the measurement database 104.

An inspection management section 105 receives the inspection method selected by the defect analysis section 102, and selects an inspection device for executing the inspection method, for example, an edge inspection device 106, film thickness inspection device 107, spectral inspection device 108, line width inspection device 109, superimposition inspection device 110, or microinspection device 111 to perform an inspection operation. It is to be noted that the inspection management section 105 is not limited to one inspection device, and a plurality of inspection devices are combined to perform the inspection operation.

The edge inspection device 106 inspects an edge rinsed cut width E, chipping, crack and the like in a circumferential edge of the semiconductor wafer 1.

The film thickness inspection device 107 inspects the film thickness formed on the surface of the semiconductor wafer 1, for example, the film thickness of the resist.

The spectral inspection device 108 measures spectral reflected light at a time when illuminative light is applied onto the surface of the semiconductor wafer 1.

The line width inspection device 109 inspects a line width or the like of, for example, a fine pattern formed on the surface of the semiconductor wafer 1.

The superimposition inspection device 110 transfers the pattern onto the surface of the semiconductor wafer 1, or measures alignment of the pattern formed on the surface of the semiconductor wafer 1.

The microinspection device 111 enlarges a specific region on the surface of the semiconductor wafer 1 using a microscope, and inspects the defect portion on the surface of the semiconductor wafer 1 from an enlarged image.

Moreover, the inspection management section 105 stores each measurement data obtained by the edge inspection device 106, film thickness inspection device 107, spectral inspection device 108, line width inspection device 109, superimposition inspection device 110, or microinspection device 111 into the measurement database 104 through the defect analysis section 102, and sends the data to a process control section 112.

The process control section 102 receives the respective measurement data from the edge inspection device 106, film thickness inspection device 107, spectral inspection device 108, line width inspection device 109, superimposition inspection device 110, and microinspection device 111, and feedback-controls operation conditions of the coater 14, exposure unit 11, and developer 15 based on the respective measurement data.

Next, an operation of the apparatus constituted as described above will be described.

The defect extraction section 100 extracts the defect portion on the semiconductor wafer 1 from difference image data before the applying of the photoresist, after the applying of the photoresist, and after the exposing/developing based on the respective image data Im₁ to Im₃ acquired by the first to third inspection sections 60 to 62.

Examples of the defect portion include dust, damage, portions s₁ to which the photoresist 3 is not applied, a portion s₂ in which a photoresist film thickness is larger than a predetermined film thickness, a portion s₃ in which the photoresist film thickness is smaller than the predetermined film thickness as shown in FIG. 14, and a portion in which the edge rinsed cut width E is not in an allowable range shown in FIG. 4B.

The defect classification section 101 obtains the characteristic amount of the defect portion extracted by the defect extraction section 100.

The defect analysis section 102 receives the characteristic amount of the defect portion obtained by the defect classification section 101, and analyzes the type of the defect portion from the characteristic amount. Moreover, the defect analysis section 102 selects the optimum inspection method for measuring the type of the defect portion in detail from the analysis result of the type of the defect portion from the inspection method selection table 103 shown in FIG. 18.

Moreover, the defect analysis section 102 stores the characteristic amount of the defect portion received from the defect classification section 101 in the measurement database 104, and stores the type of the defect portion or the selected inspection method as the analysis result in the measurement database 104.

Next, the inspection management section 105 receives the inspection method selected by the defect analysis section 102, and selects at least one of the inspection devices 106 to 111 for executing the inspection method to perform the inspection operation.

When the measurement is performed by the edge inspection device 106, film thickness inspection device 107, spectral inspection device 108, line width inspection device 109, superimposition inspection device 110, or microinspection device 111, the respective measurement data output from the respective inspection devices 106 to 111 are sent to the inspection management section 105.

The inspection management section 105 stores the respective measurement data from the respective inspection devices 106 to 111 into the measurement database 104 through the defect analysis section 102, and further sends the data to the process control section 112.

The process control section 112 receives the respective measurement data from the respective inspection devices 106 to 111, and feedback-control the operation conditions of the coater 14, exposure unit 11, and developer 15 based on the respective measurement data. For example, the defect analysis section 102 changes the operation conditions of the coater 14 in accordance with the applied state of the photoresist 3 based on the respective measurement data of the edge inspection device 106, film thickness inspection device 107 and the like. The defect analysis section 102 changes the operation conditions of the exposure unit 11, for example, based on the respective measurement data of the spectral inspection device 108, line width inspection device 109 and the like.

Thus, in the second embodiment, the method for inspecting the data portion of the semiconductor wafer 1 from the characteristic amount of the defect portion on the semiconductor wafer 1 extracted based on the respective image data Im₁ to Im₃ is selected, and the respective inspection devices 106 to 111 which execute the selected inspection method are operated to acquire the respective measurement data. Based on the respective measurement data, the operation conditions of the coater 14, exposure unit 11, and developer 15 are feedback-controlled.

Accordingly, the optimum inspection method can be selected in accordance with the type of the defect portion of the semiconductor wafer 1, and detailed inspection and measurement can be performed with respect to the defect portion. Moreover, the operation conditions of the coater 14, exposure unit 11, and developer 15 can be appropriately feedback-controlled based on the measurement data acquired by the inspection. As a result, treatment conditions of the respective steps of the photoresist applying, exposing, and developing are appropriately set, and semiconductors can be more stably manufactured.

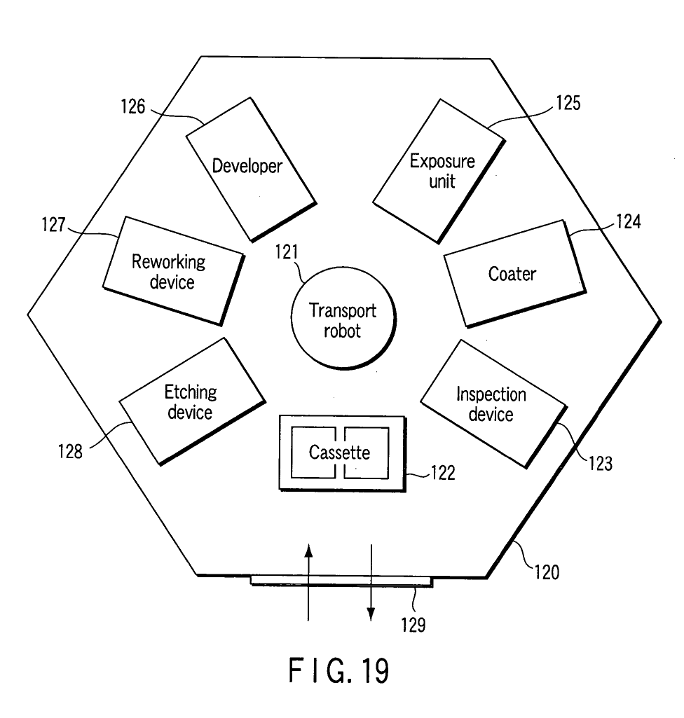

Next, a third embodiment of the present invention will be described with reference to the drawings. In the third embodiment, the first or second embodiment is applied to a semiconductor manufacturing apparatus shown in FIG. 19.

Inside a hexagonal apparatus housing 120, a cassette 122, inspection device 123, coater 124, exposure unit 125, developer 126, reworking device 127, and etching device 128 are disposed radially centering on a transport robot 121.

A semiconductor wafer 1 is stored in the cassette 122. The cassette 122 is transported into/from an outlet/inlet 129 of the apparatus housing 120.

In the inspection device 123, the first to third (fourth) inspection sections 60 to 62 (69), the surface defect inspection device 63, and process control device 87 are incorporated in the first embodiment.

In the surface defect inspection device 63, in the same manner as described in the second embodiment, the defect extraction section 100, defect classification section 101, defect analysis section 102, inspection method selection table 103, measurement database 104, inspection management section 105, edge inspection device 106, film thickness inspection device 107, spectral inspection device 108, line width inspection device 109, superimposition inspection device 110, micro inspection device 111, and process control section 112 are incorporated.

The transport robot 121 takes the semiconductor wafer 1 from the cassette 122, and transports the wafer to the inspection device 123, coater 124, inspection device 123, exposure unit 125, inspection device 123, developer 126, and inspection device 123 in this order following a treatment order of the photolithography step.

When the defective wafer is judged from the semiconductor wafer 1 by the inspection device 123, the transport robot 121 transports the semiconductor wafer 1 to the reworking device 127, and throws the wafer into the photolithography step again.

Even in the apparatus constituted in this manner, in the same manner as described in the first or second embodiment, the respective treatment results in the coater 124, exposure unit 125, developer 126, and etching device 128 are inspected by the inspection device 123, and the respective operation conditions can be independently feedback-controlled with respect to the coater 124, exposure unit 125, developer 126, and etching device 128 in accordance with the respective inspection results.

Since the etching device 128 is incorporated, patterning can be performed in one apparatus housing 120.

FIG. 20 is a constitution diagram showing an application example of the apparatus shown in the third embodiment. The respective apparatus housings 120 are arranged in such a manner that walls of a hexagonal shape are fitted into one another. The respective outlets/inlets 129 of the respective apparatus housings 120 are arranged in such a manner as to face each other, and transport paths f1, f2 of the semiconductor wafer 1 are secured.

A plurality of apparatus housings 120 are arranged in order of a film forming step of a first layer to that of an n-th layer formed on the semiconductor wafer 1. In each apparatus housing 120, a photolithography step and an etching treatment are performed to form the film of the first layer on the surface of the semiconductor wafer 1.

Moreover, the semiconductor wafer 1 is successively transported to the respective apparatus housings 120 to perform a plurality of photolithography steps and etching treatments.

To manufacture the semiconductor wafers 1 in a limited production of diversified products, when the photolithography steps and etching treatments are repeated a plurality of times in one apparatus housing 120, the films of the first layer to the n-th layer may be successively formed on the surface of the semiconductor wafer 1.

Even in the apparatus which repeats the plurality of photolithography steps to treat the semiconductor wafer 1 in this manner, the operation conditions of the coater 124, exposure unit 125, and developer 126 can be appropriately feedback-controlled, and the semiconductors can be more stably manufactured.

It is to be noted that the present invention is not limited to the first to third embodiments.

For example, the first to third inspection sections 60 to 62 are not limited to the constitution shown in FIG. 8. For example, illuminative light emitted from the illumination section 66 is not linearly formed, and the surface of the semiconductor wafer 1 may be entirely and collectively illuminated, or the surface of the semiconductor wafer 1 may be partially spot-illuminated.

In the collective illumination, the whole surface of the semiconductor wafer 1 is illuminated by planar illuminative light on average. Accordingly, an image of the whole region of the semiconductor wafer 1 can be collectively picked up. In the spot illumination, only the desired region on the semiconductor wafer 1 is illuminated by the spotted illuminative light. Accordingly, an image of only the desired region of the semiconductor wafer 1 can be picked up.

In the appearance inspection of the semiconductor wafer 1, image data of regions which are adjacent to each other and each of which has a predetermined size on the surface of the semiconductor wafer 1 may be acquired, and the image data is compared with another data to detect the defect portion. In the appearance inspection of the semiconductor wafer 1, the image data of the whole surface of the semiconductor wafer 1 is acquired, the respective image data of the regions adjacent to each other are extracted from the image data, and the image data may be compared with the other image data to detect the defect portion.

This appearance inspection is effective at the time of starting of a line, at which the non-defective semiconductor wafer is not easily obtained. After the line is stabilized, a system is switched to a non-defective comparison system in which the semiconductor wafer is compared with the non-defective semiconductor wafer.

In the respective feedback controls of the coater 14, developer 15, and exposure unit 11, inspection sections similar to the first to third inspection sections 60 to 62 are disposed in transport inlets and outlets of the semiconductor wafer 1 in the coater 14, developer 15, and exposure unit 11, and the feedback controls may be individually performed in accordance with the inspection results of the respective inspection sections.

In the inspection devices 106 to 111 for use in the second embodiment, various inspection devices such as a pattern inspection device, scanning type electronic microscope, and edge inspection device may be used as long as the devices are capable of detecting peculiar phenomena by various defects generated in various semiconductor manufacturing devices including the coater 14, developer 15, exposure unit 11 and the like, and operation conditions thereof.

The present invention is used in a surface defect inspection of a glass substrate for use in flat panel displays such as a liquid crystal display and an organic EL display, a line width inspection or a pattern inspection of each display electrode of each pixel formed on the glass substrate and the like.

1. A method of manufacturing a semiconductor, in which a semiconductor substrate is worked/treated in manufacturing steps of a semiconductor manufacturing line, the method comprising:
acquiring image data with respect to the semiconductor substrate transported into a manufacturing apparatus disposed in the manufacturing step before and after the working/treating; comparing the image data before the working/treating or master image data of the semiconductor substrate with the image data after the working/treating to detect a worked/treated state attributed to operation conditions of the manufacturing apparatus; and changing the operation conditions of the manufacturing apparatus based on the detection result to work/treat the semiconductor substrate.

2. The method of manufacturing the semiconductor according to claim 1, further comprising: comparing the image data before the working/treating with the image data after the working/treating to obtain difference image data; and detecting the worked/treated state attributed to the operation conditions of the manufacturing apparatus from defect information of the difference image data.

3. The method of manufacturing the semiconductor according to claim 1, further comprising: comparing the master image data with the image data after the working/treating to obtain difference image data; and detecting the worked/treated state attributed to the operation conditions of the manufacturing apparatus from defect information of the difference image data.

4. The method of manufacturing the semiconductor according to claim 1 or 2, wherein the manufacturing apparatus is a photoresist applying unit disposed in the semiconductor manufacturing line, the image data before the working/treating is image data before the applying of a photoresist, and the image data after the working/treating is image data after the applying of the photoresist, the method further comprising: comparing the image data before the working/treating with that after the working/treating to obtain difference image data; developing a worked/treated state attributed to operation conditions of the photoresist applying unit from data information of the difference image data; and changing the operation conditions of the photoresist applying unit based on a detection result of the worked/treated state.

5. The method of manufacturing the semiconductor according to claim 4, wherein the operation condition of the photoresist applying unit is one of a solution amount of the photoresist, a solution temperature of the photoresist, a rotation number of the photoresist applying unit, and a rotation time of the photoresist applying unit.

6. The method of manufacturing the semiconductor according to claim 4, wherein the photoresist applying unit includes an edge rinsing/cutting unit which drops a rinsing solution onto an outer peripheral edge of the semiconductor substrate coated with the photoresist to cut the photoresist into a predetermined width, the method further comprising: detecting a resist cut width of an outer peripheral edge portion of the semiconductor substrate from the image data after treatment by the photoresist; and changing an amount of the rinsing solution among the operation conditions of the photoresist applying unit based on the detection result.

7. The method of manufacturing the semiconductor according to claim 1 or 2, wherein the manufacturing apparatus is an exposure unit disposed in the semiconductor manufacturing line, the image data before the working/treating is image data before exposing, and the image data after the working/treating is image data after the exposing, the method further comprising: comparing the image data before the working/treating with that after the working/treating to obtain difference image data; detecting a worked/treated state attributed to operation conditions of the exposure unit from defect information of the difference image data; and changing the operation conditions of the exposure unit based on a detection result of the worked/treated state.

8. The method of manufacturing the semiconductor according to claim 7, further comprising: controlling one of an exposure amount by a light source, a focus amount of an optical system, a tilt of a stage, and a mask number as the operation condition of the exposure unit.

9. The method of manufacturing the semiconductor according to claim 1 or 2, wherein the semiconductor manufacturing line is a photolithography manufacturing step having each manufacturing apparatus including a photoresist applying unit, an exposure unit, and a developing unit, the method further comprising: comparing the image data before the photolithography manufacturing step with that after the photolithography manufacturing step to obtain difference image data; and detecting a worked/treated state attributed to operation conditions of the manufacturing apparatus disposed in the photolithography manufacturing step from defect information of the difference image data.

10. The method of manufacturing the semiconductor according to claim 1 or 2, wherein the semiconductor manufacturing line is a photolithography manufacturing step having each manufacturing apparatus including a photoresist applying unit, an exposure unit, and a developing unit, the method further comprising: acquiring image data before/after the applying of the photoresist of the photoresist applying unit, image data after an exposing process of the exposure unit, and image data after a developing process of the developing unit.

11. The method of manufacturing the semiconductor according to claim 1 or 3, wherein the master image data is image data of the semiconductor substrate which is non-defective after the developing of a photolithography manufacturing step having each manufacturing apparatus having a photoresist applying unit, an exposure unit, and a developing unit disposed in the semiconductor manufacturing line, and the image data after the working/treating is image data after the developing process, the method comprising: comparing the master image data with the image data after the developing process to obtain difference image data; detecting a worked/treated state attributed to operation conditions of the manufacturing apparatus disposed in the photolithography manufacturing step from defect information of the difference image data; and changing the operation conditions of the manufacturing apparatus based on a detection result of the worked/treated state.

12. The method of manufacturing the semiconductor according to any one of claims 1 to 3, wherein the image data before the working/treating, the image data after the working/treating, or the master image data is an image of the whole semiconductor substrate.

13. The method of manufacturing the semiconductor according to claim 1, wherein the semiconductor manufacturing line further comprises a reworking step with respect to the semiconductor substrate, the method further comprising: judging that the semiconductor substrate is not reworkable and is to be rejected, when the number of reworking times with respect to the same semiconductor substrate is not less than a predetermined number of times.

14. The method of manufacturing the semiconductor according to claim 1, wherein the changing of the operation condition of the manufacturing apparatus comprises: periodically sending a standard semiconductor substrate to the manufacturing steps of the semiconductor manufacturing line.

15. A method of manufacturing a semiconductor, in which a semiconductor substrate is worked/treated in manufacturing steps of a semiconductor manufacturing line, the method comprising:
acquiring image data with respect to the semiconductor substrate transported into a manufacturing apparatus disposed in the manufacturing step before and after the working/treating; storing beforehand master difference image data obtained by comparison of master image data of a non-defective article with respect to the semiconductor substrate before/after the working/treating; comparing the respective image data before/after the working/treating to obtain difference image data; detecting a worked state attributed to operation conditions of the manufacturing apparatus from the difference image data and the master difference image data; and changing the operation conditions of the manufacturing apparatus based on the detection result to work/treat the semiconductor substrate.

16. The method of manufacturing the semiconductor according to claim 15, wherein the semiconductor manufacturing line is a photolithography manufacturing step having each manufacturing apparatus including a photoresist applying unit, an exposure unit, and a developing unit, the master image data is obtained by comparison of the respective master image data of the non-defective semiconductor substrate before/after the working/treating of the photolithography manufacturing step, and the difference image data before/after the working/treating is obtained by comparison of the respective image data before/after the working/treating in the photolithography manufacturing step, the method further comprising: detecting the worked state attributed to operation conditions of the manufacturing apparatus in the photolithography manufacturing step from difference image data obtained by comparison of the obtained master difference image data with the difference image data before/after the working/treating.

17. The method of manufacturing the semiconductor according to claim 15, wherein the master difference image data is obtained by comparison of master image data before the applying of a photoresist in a photoresist applying unit of the photolithography manufacturing step with master image data after the applying of the photoresist, and difference image data between image data before/after the working/treating is obtained by comparison of the respective image data before/after the applying of the photoresist in the photoresist applying unit of the photolithography manufacturing step.

18. The method of manufacturing the semiconductor according to claim 15, wherein the master difference image data is obtained by comparison of master image data before the applying of a photoresist in a photoresist applying unit of the photolithography manufacturing step with master image data after a developing process in a developing unit of the photolithography manufacturing step, and difference image data before/after the working/treating is obtained by comparison of the respective image data before/after the developing process in the developing unit of the photolithography manufacturing step.

19. A method of manufacturing a semiconductor, in which a photolithography process is performed to work/treat a semiconductor substrate, the method comprising:
acquiring image data with respect to the semiconductor substrate transported into a photolithography manufacturing step of a semiconductor manufacturing line before and after the working/treating; detecting a worked/treated state attributed to operation conditions of a manufacturing apparatus disposed in the photolithography manufacturing step from the image data before the working/treating, or master image data with respect to the semiconductor substrate, and the image data after the working/treating; and
changing/controlling the operation conditions of the manufacturing apparatus based on the detection result to work/treat the semiconductor substrate.

20. The method of manufacturing the semiconductor according to claim 19, wherein the manufacturing apparatus includes a coater which applies a photoresist, an exposure unit which bakes a pattern, and a developer which performs a developing process, images of image data of the photoresist application in the coater before and after the working/treating, image data of exposure in the exposure unit which exposes the semiconductor substrate subjected to the working/treating of the photoresist application before and after the working/treating, and image data of developing in the developer which develops the semiconductor substrate subjected to the working/treating of the exposure before and after the working/treating are picked up by an inspection section, and an inspection process section receives the respective image data from the inspection section to perform a defect inspection with respect to the semiconductor substrate after the working/treating from difference image data obtained by comparison of the respective image data before/after the working/treating of the coater, the exposure unit, and the developer.

21. The method of manufacturing the semiconductor according to claim 19, further comprising: feedback-controlling operation conditions of the coater, the exposure unit, and the developer in accordance with detection results of treated states with respect to the semiconductor substrate, including a defective applied state of the photoresist in the coater, defective exposed states such as a defocus, mask difference, size of a masking blade, a defect on a mask, double exposure, and non-exposure in the exposure unit, or a defective developed state in the developer from an inspection result of the inspection process section.

22. The method of manufacturing the semiconductor according to claim 19, wherein the image data before the working/treating, the image data after the working/treating, or the master image data is an image of the whole semiconductor substrate.

23. The method of manufacturing the semiconductor according to claim 19, wherein the changing of the operation condition of the manufacturing apparatus comprises: periodically sending a standard semiconductor substrate to the photolithography manufacturing step.

24. The method of manufacturing the semiconductor according to claim 18, wherein the photolithography manufacturing step further comprises a reworking step with respect to the semiconductor substrate, the method further comprising: counting the number of reworking times with respect to the semiconductor substrate; and judging that the corresponding semiconductor substrate is not reworkable and is to be rejected to discharge the semiconductor substrate from the photolithography manufacturing step, when the number of the counted reworking times reaches a predetermined number of times.

25. A method of manufacturing a semiconductor, in which a photolithography process is performed to work/treat a semiconductor substrate, the method comprising:
analyzing/processing image data before and after the working/treating, acquired by an inspection section which acquires the image data with respect to the semiconductor substrate transported into a photolithography manufacturing step before and after the working/treating, or the image data after the working/treating and a pre-stored master image by an inspection process section, and inspecting the semiconductor substrate to obtain defect information after the working/treating; inspecting a worked/treated state attributed to operation conditions of a manufacturing apparatus of the photolithography manufacturing step from the inspection result; and changing the operation conditions of the manufacturing apparatus based on a comparison result of the inspection result with the operation conditions to work/treat the semiconductor substrate.

26. The method of manufacturing the semiconductor according to claim 25, wherein the inspection process section obtains the defect information of the semiconductor substrate attributed to the operation conditions of the manufacturing apparatus from difference image data obtained by comparison of the respective image data before/after the working/treating with respect to the semiconductor substrate, acquired by the inspection section, or difference image data obtained by comparison of master image data of the semiconductor substrate with the image data after the working/treating.

27. The method of manufacturing the semiconductor according to claim 25, wherein the inspection sections are disposed in a feeding line and a shipping line of the semiconductor manufacturing line in which a coater to apply a photoresist, an exposure unit to bake a pattern, and a developer to perform a developing process are disposed.

28. The method of manufacturing the semiconductor according to claim 25, wherein the semiconductor manufacturing line has a coater which applies a photoresist, an exposure unit which bakes a pattern, and a developer which performs a developing process, and the inspection section includes a first inspection section disposed on the side of a feeding line of the coater, a second inspection section disposed between the coater and the exposure unit, and a third inspection section disposed on the side of a shipping line of the developer.

29. The method of manufacturing the semiconductor according to claim 28, wherein the inspection section further includes a fourth inspection section between the exposure unit and the developer.

30. The method of manufacturing the semiconductor according to claim 25, wherein the inspection section has a line illumination section which is tilted/disposed at a predetermined angle with respect to the semiconductor substrate and which applies linear illuminative light to the semiconductor substrate, and a line image pickup section which is inclined/disposed at a predetermined angle with respect to the semiconductor substrate and which picks up an image of diffracted light or interference light from the surface of the semiconductor substrate illuminated by the illumination section, acquires diffracted image data or interference image data with respect to the semiconductor substrate, and analyzes/processes the diffracted image data and the interference image data before/after the working/treating in the defect inspection device.

31. The method of manufacturing the semiconductor according to claim 30, wherein the inspection section moves the semiconductor substrate at a constant speed along a single axis direction in one direction in such a manner that the line image pickup section picks up an interference image, and moves the semiconductor substrate in a direction reverse to the one direction in such a manner that the line image pickup section picks up a diffracted image.

32. The method of manufacturing the semiconductor according to claim 25, wherein the inspection section periodically passes a standard semiconductor substrate, and acquires image data before/after the working/treating in the manufacturing apparatus with respect to the standard semiconductor substrate treated with a photoresist, and the defect inspection device analyzes/processes the image data with respect to the standard semiconductor substrate to feedback-control operation conditions of the manufacturing apparatus.

33. The method of manufacturing the semiconductor according to claim 25, wherein the defect inspection device selects an inspection method in accordance with a type of an analyzed/processed defect portion, and the semiconductor substrate is inspected in detail by an inspection device corresponding to the selected inspection method.

34. The method of manufacturing the semiconductor according to claim 33, wherein the inspection device corresponding to the selected inspection method is one of an edge inspection device, a film thickness inspection device, a spectral inspection device, a line width inspection device, a superimposition inspection device, a microinspection device, a pattern inspection device, and a scanning type electronic microscope.

35. The method of manufacturing the semiconductor according to claim 25, wherein the image data before the working/treating, the image data after the working/treating, or the master image data is an image of the whole semiconductor substrate.

36. The method of manufacturing the semiconductor according to claim 25, wherein the changing of the operation condition of the manufacturing apparatus comprises: periodically sending a standard semiconductor substrate to the photolithography manufacturing step.

37. A method of manufacturing a semiconductor, comprising: detecting a worked/treated state attributed to an operation condition of manufacturing from image data of a whole semiconductor substrate worked/treated in each manufacturing apparatus of a semiconductor manufacturing line; and changing the operation condition of the manufacturing apparatus based on the detection result.

38. The method of manufacturing the semiconductor according to claim 37, wherein the image data is an interference image or a diffracted image of the whole surface of the semiconductor substrate.

39. The method of manufacturing the semiconductor according to claim 37, wherein the semiconductor manufacturing line is a photolithography manufacturing step having each manufacturing apparatus including a photoresist applying unit, an exposure unit, and a developing unit, and the image data is an image of the whole surface of the semiconductor substrate after photoresist working/treating, after exposure working/treating, and after developing working/treating.

40. The method of manufacturing the semiconductor according to claim 37, wherein the changing of the operation condition of the manufacturing apparatus comprises: periodically sending a standard semiconductor substrate to the semiconductor manufacturing line.

41. A semiconductor manufacturing apparatus which is disposed in a manufacturing step of a semiconductor manufacturing line and which works/treats a semiconductor substrate, the apparatus comprising:
an inspection section which acquires image data before and after the working/treating with respect to the semiconductor substrate transported into a manufacturing device disposed in the manufacturing step;
an inspection process section which detects a worked/treated state attributed to operation conditions of the manufacturing device constituting an object, from the image data before the working/treating acquired by the inspection section, or master image data of the semiconductor substrate, and the image data after the working/treating acquired by the inspection section; and
a control section which changes the operation conditions of the manufacturing device based on an inspection result of the inspection process section.

42. The semiconductor manufacturing apparatus according to claim 41, wherein the manufacturing device is a photoresist applying unit disposed in a photolithography manufacturing step, the inspection sections are disposed on a feeding side and a shipping side of the photoresist applying unit, the inspection process section compares the respective image data before/after the working/treating of the semiconductor substrate, acquired by the respective inspection sections, to obtain difference image data, and detects a worked/treated state attributed to the operation conditions of the photoresist applying unit from defect information of the difference image data, and the control section feedback-controls the operation conditions of the photoresist applying unit based on a detection result of the inspection process section.

43. The semiconductor manufacturing apparatus according to claim 41, wherein the photoresist applying unit comprises an edge rinsing/cutting unit which drops a rinsing solution onto an outer peripheral edge of the semiconductor substrate coated with the photoresist to cut the photoresist into a predetermined width, the inspection process section detects a resist cut width of an outer peripheral edge portion of the semiconductor substrate from the image data after the working/treating, acquired by the inspection section disposed on the shipping side, and the control section feedback-controls an amount of the rinsing solution among the operation conditions of the edge rinsing/cutting unit based on a detection result of the inspection process section.

44. The semiconductor manufacturing apparatus according to claim 41, wherein the manufacturing device is an exposure unit disposed in a photolithography manufacturing step, the inspection sections are disposed on a feeding side and a shipping side of the exposure unit, the inspection process section compares the respective image data before/after the working/treating of the semiconductor substrate, acquired by the respective inspection sections, to obtain difference image data, and detects a worked/treated state attributed to operation conditions of the exposure unit from defect information of the difference image data, and the control section feedback-controls the operation conditions of the exposure unit based on a detection result of the inspection process section.

45. The semiconductor manufacturing apparatus according to claim 41, wherein the manufacturing device is a developing unit disposed in the photolithography manufacturing step, the inspection sections are disposed on a feeding side and a shipping side of the developing unit, the inspection process section compares the respective image data before/after the working/treating of the semiconductor substrate, acquired by the respective inspection sections, to obtain difference image data, and detects a worked/treated state attributed to operation conditions of the developing unit from defect information of the difference image data, and the control section feedback-controls the operation conditions of the developing unit based on a detection result of the inspection process section.

46. The semiconductor manufacturing apparatus according to claim 41, wherein the manufacturing device has a photoresist applying unit, an exposure unit, and a developing unit, which are disposed in a photolithography manufacturing step, the inspection sections are disposed on a feeding line side and a shipping line side of the photolithography manufacturing step, the inspection process section compares the respective image data before/after the photolithography manufacturing step, acquired by the respective inspection sections, to obtain difference image data, and detects a worked/treated state attributed to operation conditions of the manufacturing device disposed in the photolithography manufacturing step from defect information of the difference image data, and the control section feedback-controls the operation conditions of the manufacturing device disposed in the photolithography manufacturing step based on a detection result of the inspection process section.

47. The semiconductor manufacturing apparatus according to claim 41, wherein the manufacturing device has a photoresist applying unit, an exposure unit, and a developing unit, which are disposed in manufacturing steps of a photolithography manufacturing step, the inspection section has a first inspection section disposed on a feeding line side of the photoresist applying unit, a second inspection section disposed between the photoresist applying unit and the exposure unit, and a third inspection section disposed on a shipping line side of the developing unit, the inspection process section compares the respective image data before/after the working/treating, acquired with respect to the photoresist applying unit, the exposure unit, and the developing unit by the first to third inspection sections, to obtain difference image data, and detects a worked/treated state attributed to operation conditions of the photoresist applying unit, the exposure unit, and the developing unit from these difference image data, and the control section individually controls the operation conditions of the photoresist applying unit, the exposure unit, and the developing unit based on detection results of the inspection process section.

48. The semiconductor manufacturing apparatus according to claim 47, wherein the inspection section further includes a fourth inspection section disposed between the exposure unit and the developing unit, in addition to the first inspection section disposed on the feeding line side of the photoresist applying unit, the second inspection section disposed between the photoresist applying unit and the exposure unit, and the third inspection section disposed on the shipping line side of the developing unit.

49. The semiconductor manufacturing apparatus according to claim 48, wherein the inspection process section stores beforehand the image data of the non-defective semiconductor substrate, acquired by the first to third inspection sections or the fourth inspection section as master image data, and compares the respective image data after each manufacturing step, acquired by the second and third inspection sections or the fourth inspection section, with the master image data of the manufacturing step to obtain difference image data for each manufacturing step.

50. The semiconductor manufacturing apparatus according to claim 47 or 49, wherein the inspection process section obtains the respective image data of the non-defective semiconductor substrate before/after the manufacturing step of the photolithography manufacturing step as master image data, stores beforehand master difference image data obtained by comparison of the respective master image data before/after the manufacturing step, corresponding to the manufacturing step, compares the respective image data before/after the manufacturing step to obtain difference image data, and detects a worked state attributed to operation conditions of the manufacturing device from the difference image data for each manufacturing device, obtained by comparison of the difference image data for each manufacturing step with the master difference image data corresponding to the manufacturing step.

51. The semiconductor manufacturing apparatus according to claim 41, wherein the manufacturing device has a photoresist applying unit, an exposure unit, a developing unit, a cassette to store the semiconductor substrate, and a transport robot to take the semiconductor substrate from the cassette, which constitute a photolithography manufacturing step, the photoresist applying unit, the exposure unit, the developing unit, and the inspection section are disposed centering on the transport robot, and the transport robot transports the semiconductor substrate into the inspection section before and after the working/treating in the respective manufacturing steps by the photoresist applying unit, the exposure unit, and the developing unit.

52. The semiconductor manufacturing apparatus according to claim 41, wherein the inspection section has a line illumination section which is tilted/disposed at a predetermined angle with respect to the semiconductor substrate and which applies linear illuminative light to the semiconductor substrate, a line image pickup section which is inclined/disposed at a predetermined angle with respect to the semiconductor substrate and which picks up an image of diffracted light or interference light from the surface of the semiconductor substrate illuminated by the illumination section, and a stage on which the semiconductor substrate is laid and which moves at a constant speed in a single axial direction, and moves the stage while the image pickup section picks up an interference image or a diffracted image of the surface of the semiconductor substrate.

53. The semiconductor manufacturing apparatus according to claim 41, wherein a standard semiconductor substrate is periodically sent to the photolithography manufacturing step instead of the semiconductor substrate, the inspection section acquires the respective image data before/after the working/treating with respect to the standard semiconductor substrate worked/treated for each manufacturing step, the inspection process section analyzes the image data with respect to the standard semiconductor substrate to detect the worked/treated state attributed to the operation conditions of the manufacturing device constituting an object, and the control section automatically calibrates the operation conditions of the manufacturing device based on an inspection result of the inspection process section.

54. The semiconductor manufacturing apparatus according to claim 41, wherein the changing of the operation condition of the manufacturing device comprises: periodically sending a standard semiconductor substrate to the semiconductor manufacturing line.

55. The semiconductor manufacturing apparatus according to claim 41, wherein the semiconductor manufacturing line further comprises a reworking step with respect to the semiconductor substrate, and the inspection process section judges that the corresponding semiconductor substrate is not reworkable, when a number of reworking times reaches a predetermined number of times.
